(19) United States
(12) Patent Application Publication
(10) Pub. No.: US 2025/0130387 A1
(43) Pub. Date: Apr. 24, 2025

(54) CUSTOMIZABLE FIXATION DEVICE ASSEMBLY FOR FIXING DIFFERENT NUMBERS OF CABLES TO A TELECOMMUNICATIONS ENCLOSURE

(71) Applicant: CommScope Technologies LLC, Hickory, NC (US)

(72) Inventors: Philippe COENEGRACHT, Hasselt (BE); Matthew CAMPSTEYN, Hoeselt (BE)

(73) Assignee: CommScope Technologies LLC, Hickory, NC (US)

(21) Appl. No.: 18/688,240

(22) PCT Filed: Aug. 30, 2022
(86) PCT No.: PCT/US2022/042051

§ 371 Date: Feb. 29, 2024

Related U.S. Application Data
(60) Provisional application No. 63/239,043, filed on Aug. 31, 2021.
(60) Provisional application No. 63/323,569, filed on Mar. 25, 2022.

(51) Int. Cl. G02B 6/44

(52) U.S. Cl. CPC G02B 6/4471

(57) ABSTRACT

Multi-piece device assemblies for fixing cables, such as fiber optic cables, in a telecommunications closure. Features of the assemblies can improve versatility and flexibility in fixing different numbers of cables at different times, as network and connectivity needs for the telecommunications closure change. In an embodiment, the assembly includes two body pieces that can each support a cable fixation and that removably interlock with each other.

### CROSS-REFERENCE TO RELATED APPLICATIONS

This application is being filed on Aug. 30, 2022 as a PCT International Patent Application and claims the benefit of U.S. Patent Application Ser. No. 63/239,043, filed on Aug. 31, 2021 and claims the benefit of U.S. Patent Application Ser. No. 63/323,569, filed on Mar. 25, 2022, the disclosures of which are incorporated herein by reference in their entireties.

### TECHNICAL FIELD

The present disclosure relates to telecommunications enclosures, and more particularly to devices for fixing portions of telecommunications cables to telecommunications enclosures.

### BACKGROUND

Telecommunications systems typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures or “closures” are adapted to house and protect telecommunications components such as optical fibers, fiber splices, termination panels, power splitters, wave division multiplexers, fiber management trays, cable organizing and routing components, etc.

Typically, cables holding optical fibers entering telecommunications enclosures must be fixed in place inside the enclosure. Within the closure, and depending on the type of cable, protective components of the cable, such as a jacket, a buffer tube, strength members, etc., are stripped, truncated, or removed, allowing the optical fibers held by the cable to be managed (e.g., routed, split, spliced, stored) within the closure.

### SUMMARY

In general terms, the present disclosure is directed to improvements in telecommunications cable management and, more particularly, in telecommunications closures and in fixation of cables at telecommunications closures.

Devices according to the present disclosure can improve customizability and adaptability of cable fixation at telecommunications closures.

Devices according to the present disclosure can enhance selectability of a desired number of cables for fixation at a given cable fixation location in a telecommunications closure.

Devices according to the present disclosure can improve versatility of telecommunications cable closure organizers in accommodating different numbers of cables.

A given telecommunications closure is configured to route fibers from one or more provider side telecommunications cables to one or more subscriber side telecommunications cables. For example, telecommunications closures can route fibers between incoming feeder cables and outgoing drop cables, between incoming feeder cables and outgoing branch cables, between incoming branch cables and outgoing branch cables, between incoming branch cables and outgoing drop cables, and so forth. The cables enter the closure, typically through sealed ports defined by the closure, and the fibers of those cables are then managed within the interior volume of the closure by a technician. Fiber management can include, for example, fiber storage (typically in loops or portions of loops), splicing, splitting, wave division multiplexing, indexing, and so forth.

A given telecommunications closure can support one or more of: feeder cables, branch cables, connectorized and non-connectorized drop (or distribution) cables, loose fibers, fiber ribbons, etc. Some cables that enter a telecommunications closure include rigid strength rods that must be fixed relative to the closure. Some cables that enter a telecommunications closure include strength yarn, e.g., made from aramid fibers, that must be fixed relative to the closure. Some fibers are spliced to other fibers at splices that are supported within the closure. Ends of drop cables that enter a closure can be connectorized or not connectorized.

The portions of the cables that enter the closure through the closure ports are typically jacketed with outer protective jackets. Seal blocks positioned at the cable ports seal around the outer jackets of the cables. For feeder cables and drop cables, the bare fibers are exposed within the closure by stripping the outer jacket, and a remaining end portion of the outer jacket is fixed to cable fixation devices within the closure. Exposed aramid yarn and/or rigid strength rods of such cables are also anchored within the closure, often to the same cable fixation assembly as the outer jacket. Fixation of cables and strength members relative to the closure can help to avoid fiber breakage and disruption of the closure seal due to lateral loads on the cables.

Different regions of a closure volume can be set up for different types of cable fixation and fiber management. For example, a closure can include a main support structure that can support feeder cable fixation on one side of the structure and connectorized and non-connectorized drop cables on the opposite side.

The contents of International PCT Publication No. WO2020/154418 filed Jan. 22, 2020 and International PCT Application No. PCT/US2021/017678 filed Feb. 11, 2021 are hereby incorporated by reference in their entireties.

In accordance with certain specific aspects of the present disclosure, a fixation device assembly for fixing one or more cables in a telecommunications closure, includes a fixation body, the fixation body including a first body piece and a second body piece configured to lockingly interface with each other, the fixation device assembly being configured to define a first fixation configuration in which the first body piece and the second body piece are not lockingly interfaced with each other, and a second fixation configuration in which the first body piece and the second body piece are lockingly interfaced with each other, the fixation device assembly being adapted in the first configuration to fix a first cable to the first body piece, the fixation device assembly being adapted in the second configuration to fix the first cable to the first body piece and a second cable to the second body piece.

In accordance with further aspects of the present disclosure, a method of fixing one or more cables in a telecommunications closure, includes steps of: (a) providing a first body piece of a cable fixation assembly; (b) fixing a first cable to the first body piece; (c) subsequent to the step (b), fixing a second cable to a second body piece of the cable fixation assembly; and (d) subsequent to the step (b), interlocking the second body piece and the first body piece.

In accordance with further aspects of the present disclosure, a method of fixing one or more cables in a telecommunications closure, includes steps of: (a) providing a first body piece of a cable fixation assembly; (b) fixing a first cable to the first body piece; (c) subsequent to the step (b) mounting the first body piece to a baseplate; (d) subsequent to the step (c), fixing a second cable to a second body piece of the cable fixation assembly; and (e) subsequent to the step (d), interlocking the second body piece and the first body piece.

In accordance with further aspects of the present disclosure, a fixation device assembly for fixing one or more cables in a telecommunications closure, includes: a fixation body, the fixation body including a first body piece and a second body piece configured to lockingly interface with each other, the fixation device assembly being configured to define a first fixation configuration in which the first body piece and the second body piece are not lockingly interfaced with each other, and a second fixation configuration in which the first body piece and the second body piece are lockingly interfaced with each other, the fixation device assembly being adapted in the first configuration to fix a first cable to the first body piece, the fixation device assembly being adapted in the second configuration to fix the first cable to the first body piece and a second cable to the second body piece, wherein the first body piece includes: a pocket; a ramped projection positioned in the pocket, the ramped projection defining a shoulder; and a flexibly resilient arm; and wherein the second body piece includes: an extension having a catch, the extension being configured to be inserted in the pocket in a first direction and then slid within the pocket in a second direction perpendicular to the first direction such that the catch lockingly interfaces with the shoulder; and a retainer configured to flex the arm when the extension is slid within the pocket in the second direction and to lockingly engage the arm.

In accordance with further aspects of the present disclosure, a method of fixing one or more cables in a telecommunications closure, includes: providing a first body piece of a cable fixation device assembly; and interlocking the second body piece and the first body piece by inserting in a first direction a portion of the second body piece into a portion of the first body piece and then sliding in a second direction the portion of the second body piece within the portion of the first body piece, such that the portion of the second body piece interlocks with the first body, the second direction being perpendicular to the first direction.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of a telecommunications closure in accordance with the present disclosure, the closure being in a closed configuration.

FIG. 2 is a perspective view of the housing pieces of the closure of FIG. 1.

FIG. 3 is perspective view of an optical fiber organizer that can be housed in the closure of FIG. 1.

FIG. 4 is a further perspective view of the organizer of FIG. 3.

FIG. 5 is an enlarged view of the called-out portion in FIG. 4.

FIG. 6 is a perspective view of the cable fixation assembly of the organizer of FIG. 3.

FIG. 7 is a further perspective view of the cable fixation assembly of FIG. 6.

FIG. 8 is a further perspective view of the cable fixation assembly of FIG. 6.

FIG. 9 is a further perspective view of the cable fixation assembly of FIG. 6.

FIG. 10 is a partially exploded view of the cable fixation assembly of FIG. 6.

FIG. 11 is a perspective view of the cable fixation device of the assembly of FIG. 6, the device being in a two-cable fixation configuration.

FIG. 12 is a further perspective view of the cable fixation device of FIG. 11.

FIG. 13 is a side, planar view of the cable fixation device of FIG. 11.

FIG. 14 is a further side, planar view of the cable fixation device of FIG. 11.

FIG. 15 is a perspective, exploded view of the cable fixation device of FIG. 11.

FIG. 16 is a further perspective, exploded view of the cable fixation device of FIG. 11.

FIG. 17 is a perspective view of a cable fixation assembly, including a portion of the assembly of FIG. 6, and with the cable fixation device being in a one-cable fixation configuration.

FIG. 18 is a perspective view of the cable fixation device of FIG. 17, including a single drop cable fixed to the device.

FIG. 19 is a perspective view of the cable fixation device of FIG. 11, including two drop cables fixed to the device.

FIG. 20 is a perspective view of a further example cable fixation device according to the present disclosure.

FIG. 21 is a further perspective view of the device of FIG. 20.

FIG. 22 is an exploded view of the device of FIG. 20.

FIG. 23 is a further exploded view of the device of FIG. 20.

FIG. 24 is a further exploded view of the device of FIG. 20.

FIG. 25 is a perspective view of one of the pieces of the device of FIG. 20.

FIG. 26 is a further perspective view of the piece of FIG. 25.

FIG. 27 is a perspective view of another of the pieces of the device of FIG. 20.

FIG. 28 is a further perspective view of the piece of FIG. 27.

FIG. 29 is a planar view of a portion of the device of FIG. 20 in a disengaged configuration.

FIG. 30 is a perspective, cross-sectional view of the portion of FIG. 29 along the line A-A of FIG. 29.

FIG. 31 is an enlarged view of the called-out portion of FIG. 30.

FIG. 32 is a planar view of a portion of the device of FIG. 20 in a first engaged configuration.

FIG. 33 is a perspective, cross-sectional view of the portion of FIG. 32 along the line B-B of FIG. 32.

FIG. 34 is an enlarged view of the called-out portion of FIG. 33.

FIG. 35 is a planar view of a portion of the device of FIG. 20 in a second engaged configuration.

FIG. 36 is a perspective, cross-sectional view of the portion of FIG. 35 along the line C-C of FIG. 35.

FIG. 37 is an enlarged view of the called-out portion of FIG. 36.

FIG. 38 is a planar view of a portion of the device of FIG. 20 in the second engaged configuration.

FIG. 39 is a perspective, cross-sectional view of the portion of FIG. 38 along the line D-D of FIG. 38.

FIG. 40 is an enlarged view of the called-out portion of FIG. 39.

FIG. 41 is a planar view of a portion of the device of FIG. 20 in the second engaged configuration.

FIG. 42 is a cross-sectional view of the portion of FIG. 41 along the line E-E of FIG. 41.

FIG. 43 is an enlarged view of the called-out portion of FIG. 42.

FIG. 44 is a further example cable fixation device according to the present disclosure, and including a pair of cables affixed thereto.

FIG. 45 is a perspective view of the device of FIG. 44.

FIG. 46 is an exploded view of the device of FIG. 44.

FIG. 47 is a further exploded view of the device of FIG. 44.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

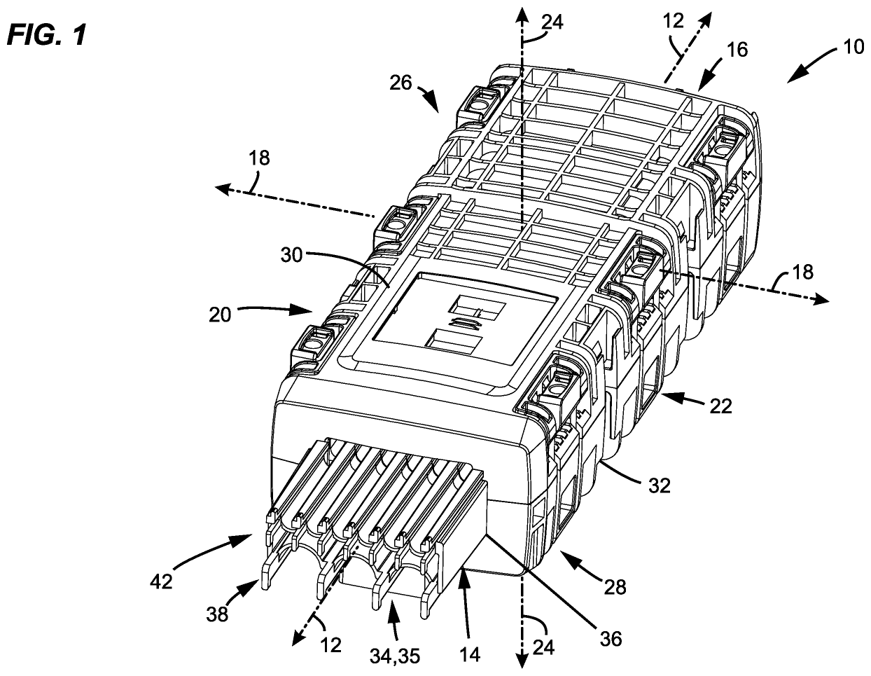

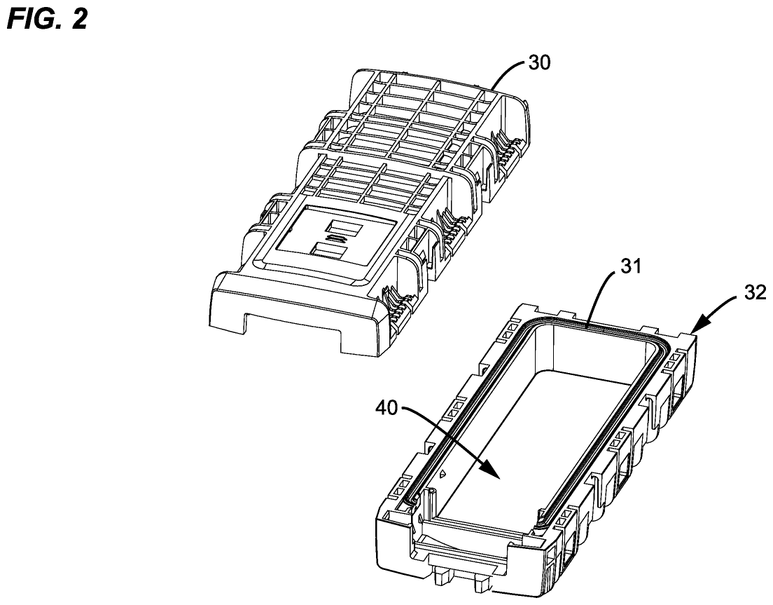

Referring to FIGS. 1-2, a telecommunications closure 10 extends along a longitudinal axis 12 between a proximal end 14 and a distal end 16. The closure 10 extends along a transverse axis 18 between a first side 20 and a second side 22. The closure 10 extends along a vertical axis 24 between a top 26 and a bottom 28. The axes 12, 18 and 24 are mutually perpendicular, with the axes 12 and 18 defining a horizontal plane.

As used herein, terms such as proximal, distal, top, bottom, upper, lower, vertical, horizontal and so forth will be used with reference to the axes 12, 18, and 24 of FIG. 1 and in relating the positions of one component to another with respect to the full closure assembly of FIG. 1. These relative terms are for ease of description only, and do not limit how the closure 10 or any individual component or combination of components, may be oriented in practice.

The closure 10 includes a first upper housing piece 30 and a second lower housing piece 32 that cooperate (e.g., with hinges, clamps, etc.) to form a sealable and re-enterable closure volume 40. A perimeter seal element 31 forms a seal about three sides of the closure volume 40 when the closure 10 is in a sealed and closed configuration.

The closure volume 40 is configured to house a cable organizer 34. An internal portion (not shown in FIGS. 1-2) of the cable organizer 34 is positioned within the closure volume 40. An external portion 35 of the cable organizer 34 is positioned exterior to the closure volume 40, with the cable organizer 34 extending through a proximally positioned opening 36 defined between the proximal ends of the first and second housing pieces 30 and 32. Cables enter the closure volume 40 via the opening 36 and sealed cable ports defined by cable sealing bodies (not shown) positioned at the opening 36 and mounted as part of the internal portion of the cable organizer 34.

The cable organizer 34 is configured to accommodate relatively thick cables (such as feeder cables) entering the closure 10 via a lower portion 38 of the cable organizer 34, and relatively thin cables (such as drop cables) entering the closure via an upper portion 42 of the cable organizer 34.

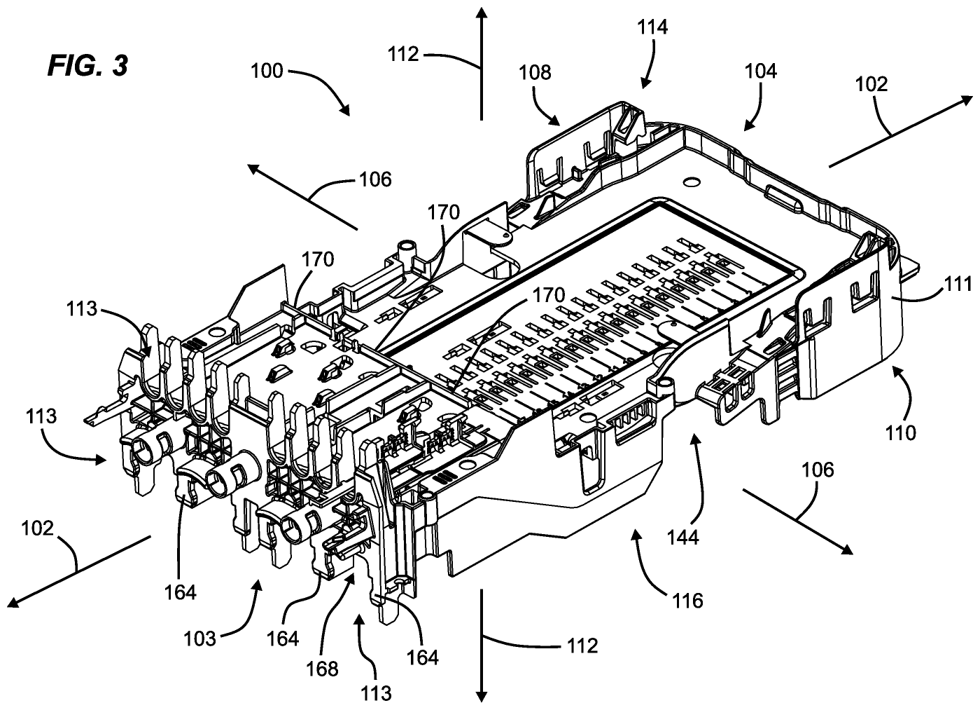

Referring now to FIGS. 3-5, a cable organizer (or organizer) 100 in accordance with the present disclosure will be described. The cable organizer 100 can cooperate with housing pieces of a closure such as described above. For example, the cable organizer 100 can cooperate with the housing pieces 30, 32 as described above with respect to FIGS. 1 and 2, an internal portion of the organizer being positioned in the closure volume 40. In some examples, other than at the proximal side, the housing pieces do not form another opening to the outside of the closure. In other examples, an additional opening can be formed between the housing pieces. Such an additional opening can be configured, for example, to accommodate a valve or valve assembly that can be used for pressurizing the interior volume of the closure.

The organizer 100 extends along a longitudinal axis 102 from a proximal end 103 to a distal end 104, along a transverse axis 106 from a first side 108 to a second side 110, and along a vertical axis 112 from a top 114 to a bottom 116. The axes 102, 106 and 112 are mutually perpendicular, with the axes 102 and 106 defining a horizontal plane. Seal blocks (not shown) can be provided in the regions 113. The seal blocks can sealingly receiver telecommunications cables, (e.g., feeder cables, drop cables, branch cables) entering the closure through ports defined by the seal blocks.

The organizer 100 is generally divided by one or more panels, walls, or other structures between an upper portion 122 and a lower portion 124. Some of these panels, walls and other structures form an integrated unit that serves as a main support structure 111 of the organizer 100. The organizer 100 defines one or more channels and other guiding structures (e.g., structures that define pathways 144) for guiding optical fibers between the upper and lower portions, such that an optical fiber from a cable (e.g., a feeder cable) fixed in the lower portion can be optically coupled to an optical fiber of a cable (e.g., a drop cable) fixed in the upper portion. In addition, fibers can be routed from one cable to another cable entering the closure on the same side of the main support structure 111, e.g., from a feeder cable entering the closure on the lower side to a drop cable entering the closure on the lower side.

The main support structure 111 can be constructed (e.g., molded) of a polymeric material, or machined from metal (e.g., sheet metal). The main support structure 111 includes in the upper portion 122 a cable fixation region 126 and a fiber management region 128 positioned distally from the cable fixation region 126. The main support structure 111 can also include in the lower portion a cable fixation region, and a fiber management region positioned distally from the cable fixation region. The upper and lower cable fixation regions are generally vertically aligned. The upper and lower fiber management regions are generally vertically aligned.

The lower fiber management region 132 is partially defined by a side wall 134, that together with the downward facing surface of the panel 138, together form a basket that can serve as a storage area for looped fiber from feeder cables. Such looped fiber can be in the form of loose fibers, loose fibers protected in groups by a common sheath, fiber ribbons, etc. Fibers can be guided from the lower fiber management region to the upper fiber management region where they can be further managed, e.g., with splices, connectors and adapters, splitters, wave division multiplexors, etc.

The upper fiber management region 128 includes an upward facing horizontal surface 140 of the panel 138. The surface 140 defines mounting structures 142 for mounting optical fiber management components, such as splitter holders and/or splice holders. Fiber retainers 146 are also provided in the upper fiber management region 128 and retain fibers (e.g., fibers 61) extending from cables (e.g., cables 60am 60b) (FIGS. 18-19) within the upper fiber management region 128 while enabling compliance with bend radius limitations of the optical fibers.

In some examples, the upper fiber management region includes one or more banks of fiber optic adapters (not shown) that can be used to optically connect connectorized fibers of drop cables having connectors with connectorized fibers of other cables.

In some examples, non-connectorized drop cables can be fixed in the upper cable fixation region 126 and their fibers managed in the upper fiber management region 128. Thus, the upper fiber management region of the organizer 100 can accommodate connectorized drop cables, non-connectorized drop cables, or a combination of connectorized and non-connectorized drop cables. Other cable types and configurations can also be accommodated and managed at the cable fixation region 126. In alternative examples, the adapters, or non-functional receptacles that behave like one-sided adapters, can serve as parking or storage for the connectors terminating optical fibers.

The upper cable fixation region 126 and the corresponding lower cable fixation region are separated by a wall 154 of the main support structure 111. The wall includes an upward facing horizontal surface 156 and an opposing downward facing horizontal surface. These are back-to-back and can support cable fixation assemblies as will be described in greater detail below.

Positioned proximally of the cable fixation regions is the seal region 113 of the organizer 100. The seal region 113 includes a plurality of dividers 162 and 164 in the upper portion 122 and the lower portion 124, respectively, of the organizer 100. The dividers 162 define openings 166 through which connectorized drop cables 60 and non-connectorized drop cables (or other types of cables) enter the closure. The dividers 164 define openings 168 through which feeder cables or the types of cables (e.g., drop cables 60) enter the closure. The dividers 162 and 164 are provided in two rows in the upper portion 122 spaced apart longitudinally from each other and two rows and in the lower portion 124 spaced apart longitudinally from each other. In the space between rows of dividers there are placed seal blocks (not shown). The seal blocks form seals around the cables entering the closure. The seal blocks also serve to seal off the proximal opening of the closure defined between the housing pieces of the closure.

The cable fixation regions are used to fix cables entering the closure through ports defined by seal blocks between the dividers 162 and 164, respectively. Optical signals can be routed from a feeder cable to a drop cable via the organizer 100. The number and type of cables extending through cable ports into the closure can depend on the particular fiber management needs of the closure. In some examples, one or more of the ports can be plugged and not receive any cable. Whatever the configuration of cables entering the cable ports at the cable fixation regions, those cables must be affixed in the cable fixation region to minimize unwanted movement of the cables, which can damage optical fibers and other structures in the closure volume.

Various features of a cable fixation device and assembly for affixing the cables at the fixation region 126 will now be described.

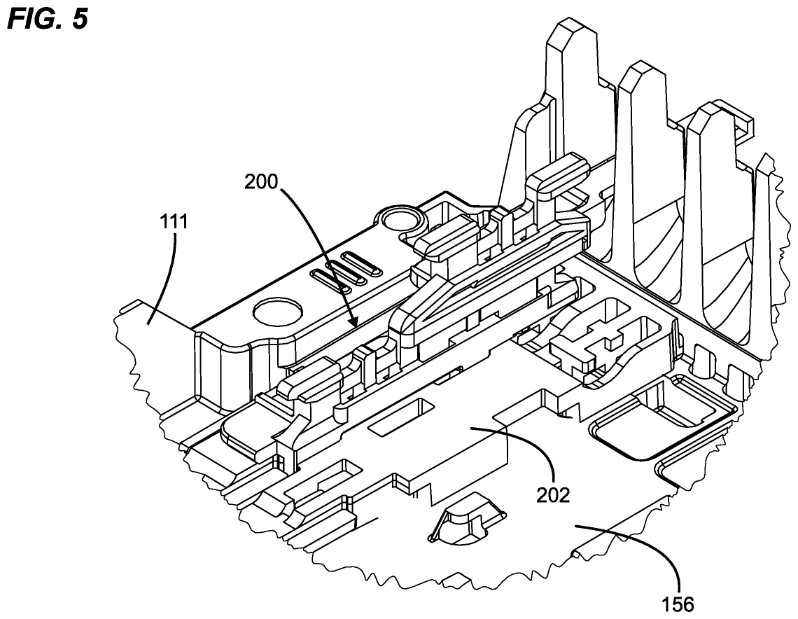

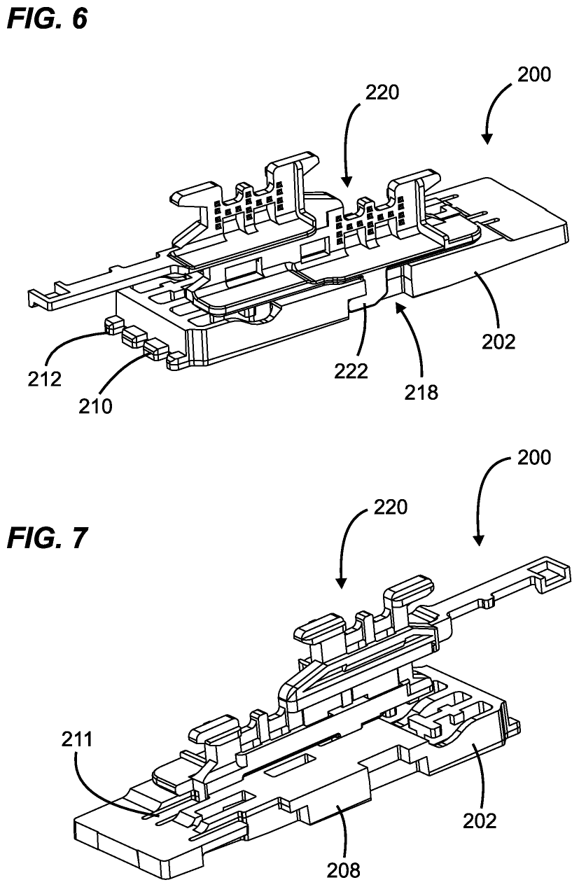

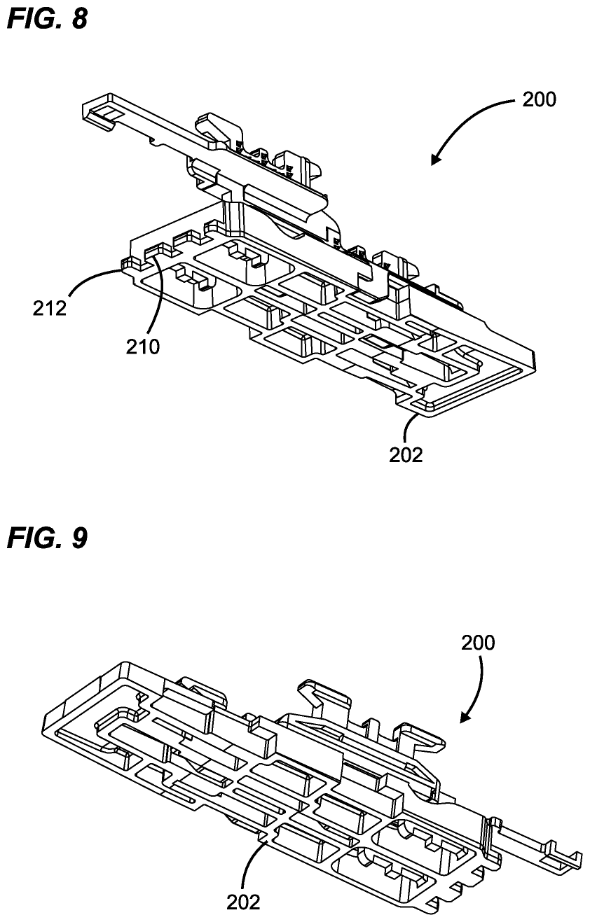

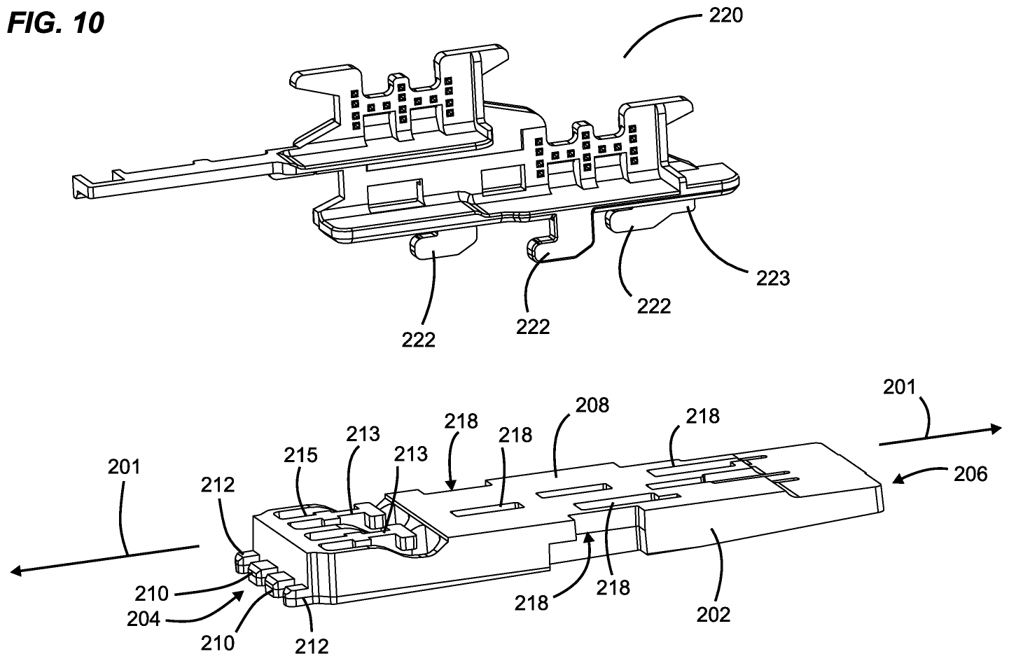

Referring to FIGS. 5-10, a cable fixation assembly 200 is configured to be removably mounted to the main support structure 111 at the surface 156. The assembly 200 includes a baseplate 202 and a cable fixation device 220 that mounts to the baseplate 202. The baseplate 202, in turn, mounts directly to the main support structure 111. In particular, the baseplate 202 is configured to be secured to the surface 156. The baseplate can serve as a platform to properly vertically align the device 220 with a cable port defined by the seal blocks.

More specifically, the baseplate 202 is configured to lockingly mount drop cable fixation devices, such as the device assembly (or, simply, device) 220. The baseplate 202 extends along an axis 201 from a proximal end 204 to a distal end 206, and includes a baseplate body 208. The body 208 is constructed of a sturdy, flexibly resilient material. For example, the body 208 can be a molded polymeric material.

The body 208 defines slots 218. The slots 218 are configured to receive hook members of a cable fixation device, such as the hook members 222 of the device 220. The body includes a cantilever 211 at one of the slots 218. The cantilever 211 deflects as the hook members 222 are inserted into the slots 218. The device 220 is then moved proximally, causing the cantilever 211 to resiliently return to its unflexed position, thereby locking the device parallel to the axis 201. When inserting the hook members 222 into the slots 218 to mount the device 220 to the baseplate 202, a heel portion 223 of one of the hook members 222 engages the cantilever 211 and flexes the cantilever 211 downward to allow the hook members 222 to slide proximally under the body 208.

The body 208 defines T-shaped tabs 213 having notches configured for securing cable tie wraps. In some examples, a tie wrap (e.g., a zip tie) can be looped around the outer jacket of a drop cable, for example, and around a T-shaped tab 213 within a notch 215 to fix the cable directly to the baseplate 202.

The main support structure 111 includes stop walls 170 (FIG. 3). Each stop wall 170 projects upwardly from the surface 156.

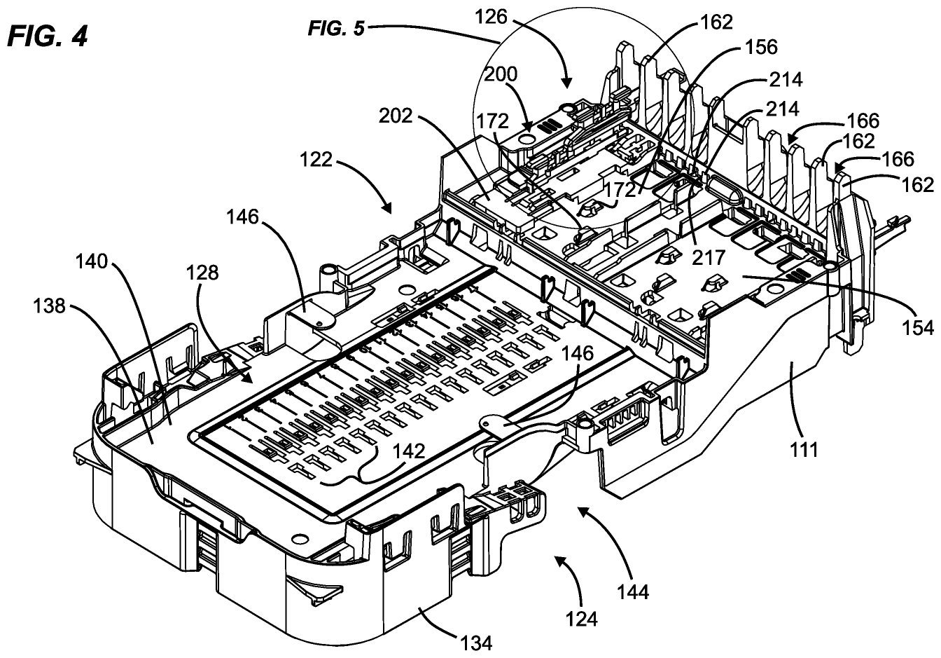

Projecting proximally from the body 208 are feet 210 and 212. To mount the baseplate 202 to the main support structure 111, the feet 210 and 212 are received in footholds 214 (FIG. 4) defined by the main support structure 111. The footholds are separated by partitions 217, which can inhibit side to side movement of an installed baseplate 202.

To install the baseplate 202, the feet 210, 212 can be slid into the footholds 214. Then, the base plate can be flexed, and the distal end 206 lowered until the distal end 206 touches or nearly touches the surface 156. The baseplate 202 can then be released to securely install it to the main support structure 111 at the surface 156. The baseplate 202 is sized such that, when installed (i.e., mounted at the surface 156), the wall 170 frictionally abuts and holds the distal end 206 of the baseplate 202, while the interfacing of feet 210, 212 and footholds 214, further secures the baseplate 202 to the main support structure 111.

Thus, the baseplate 202 is configured not to require locking engagement with the mounting structures 172 defined by the main support structure 111 in order to be secured to the main support structure 111.

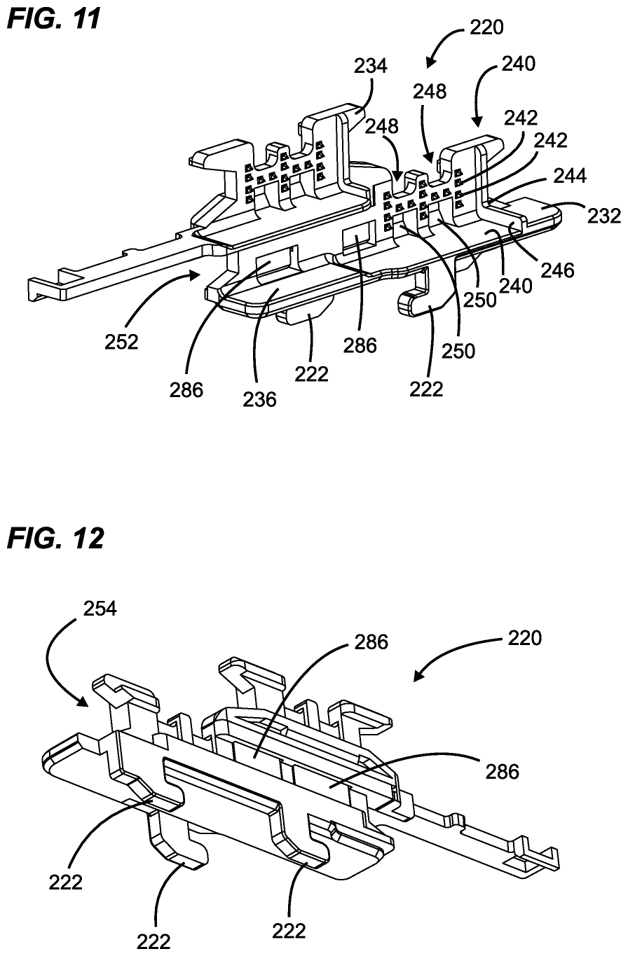

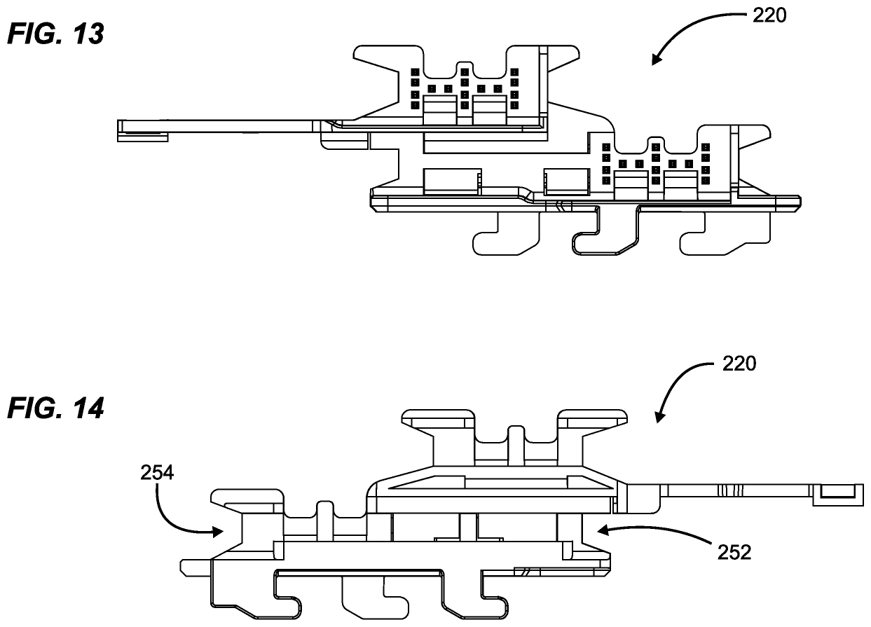

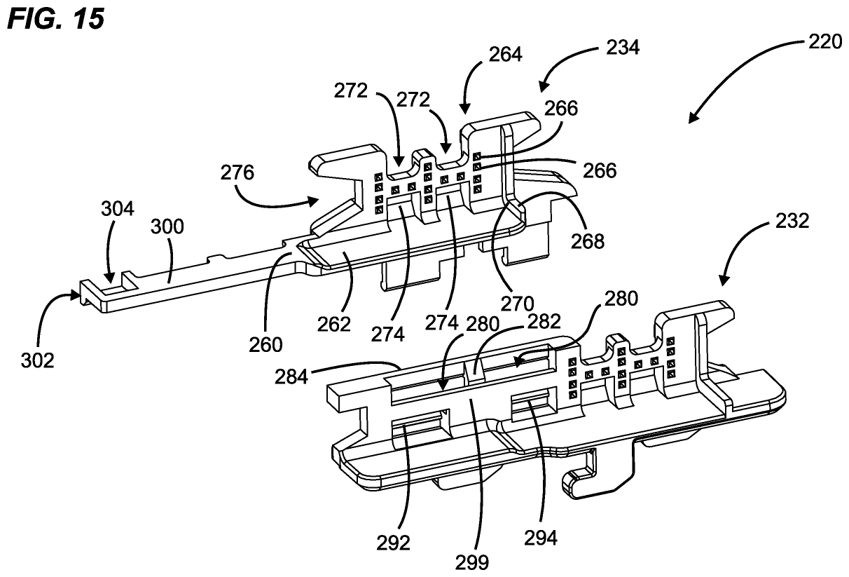

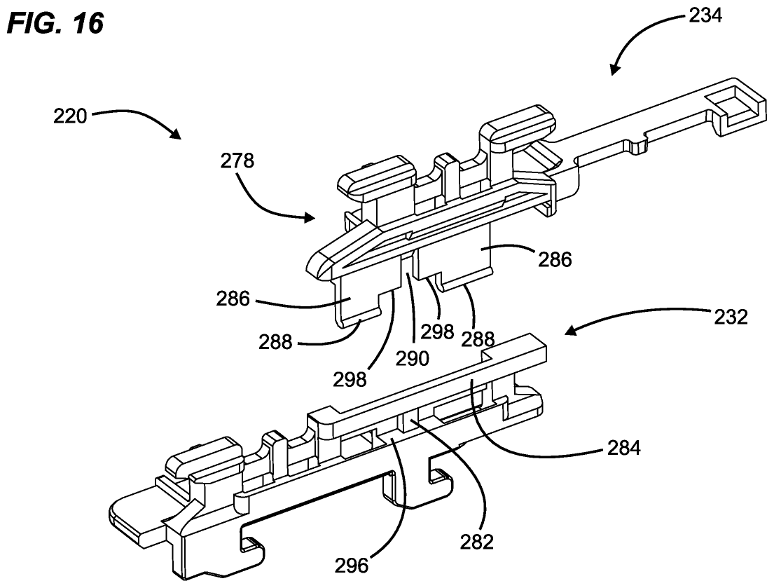

Referring now to FIGS. 11-19, the cable fixation device 220 will be described. The cable fixation device 220 is configured to be customized for fixing one or two cables. Typically, an outer jacket of a cable is affixed to the body of a cable fixation device before being mounted to a baseplate. The baseplate is typically mounted to the main support structure of the optical fiber organizer before the cable fixation body is mounted to the baseplate.

A given telecommunications closure may require initially only one drop cable entering the closure at a given drop cable port. In such a situation, providing a cable fixation device having a body that can individually fix two cables can be disadvantageous. For example, the structural portion of the device designed to fix the second cable can interfere with fixation of the first cable, inhibiting or complicating proper fixation of the first cable.

In addition, when fixing two cables to the same device, a sealing element (e.g., a mass of gel) may be required to be placed between the cables to seal off any gaps that may naturally form between the two cables where the cables pass through the same port in the seal blocks of the closure, particularly cables having round or curved outer jackets. Such a sealing element can require additional structure to support it, such as an additional structure of the fixation body. However, such additional structure is not needed if only one cable is being fixed to the device, and the additional structure is then unnecessary and can potentially compromise the seal between the seal blocks and the outer jacket of the cable.

The device assembly 220 is configured to mitigate one or more of the foregoing disadvantages.

The device 220 is configured to clamp with tie wraps (e.g., with zip ties 63) non-connectorized drop cables 60a, 60b, whose outer jackets 65 have had their distal portions stripped, exposing the optical fiber(s) 61 and strength yarn 69.

The device 220 includes a fixation body 230. The fixation body 230 includes a first (or lower) body piece 232 and a second (or upper) body piece 234 that are configured to lockingly interface with each other.

The fixation device 230 is configured to define a first fixation configuration, as shown in FIG. 18, in which the first body piece 232 and the second body piece 234 are not lockingly interfaced with each other.

In some examples, the first body piece 232 and the second body piece 234 are each a molded polymeric material.

The fixation device 230 is configured to define a second fixation configuration, as shown in FIG. 19, in which the first body piece 232 and the second body piece 234 are lockingly interfaced with each other.

In the first fixation configuration (FIG. 18) the fixation device 220 is adapted, as shown, to fix a first cable 60a to the first body piece 232.

In the second fixation configuration (FIG. 19), the fixation device 220 is adapted to fix the first cable 60a to the first body piece 232 and a second cable 60b to the second body piece 234.

In both configurations, the outer jackets 65 of the cables 60a, 60b can be secured to the fixation device 220 with one or more tie wraps, such as the zip ties 63.

The first body piece 232 includes the hook members 222. The first body piece 232 includes a cable jacket support surface 236 that defines a recess 238 to allow a tie wrap to pass between the surface 236 (in the recess 238) and the outer jacket of the cable to secure the cable at a jacket fixation portion 240 defined by the first body piece 232. Teeth 242 are positioned on the jacket fixation portion 240 and configured to dig into the cable jacket to help secure it.

The first body piece 232 includes a shoulder stop 244 configured to help place the distal end of the cable jacket when securing the cable to the first body piece 232. Thus, the shoulder stop 244 is configured to inhibit distal movement of the cable jacket when an axial end of the cable jacket abuts the proximally facing surface 246 of the shoulder 244.

The jacket fixation portion 240 includes notches 248 and fully enclosed openings 250 that receive tie wraps that are wrapped around the outer jacket of a cable in order to fix the outer jacket to the first body piece 232.

The first body piece 232 defines a proximal notch 252 and a distal notch 254 that is aligned with the proximal notch along the proximal to distal dimension. The notches 252 and 254 are configured to receive the strength yarn 69 (e.g., aramid yarn) extending from the cable fixed to the first body piece 232. That is, the strength yarn 69 can be anchored by winding it around the first body piece through the notches 248 and 254, and then tied off. In this manner, both the outer jacket of the cable and the strength yarn are fixed to the first body piece 232, which can minimize deleterious impact of a lateral load experienced by the cable on any optical fibers carried by the cable.

The second body piece 234 includes a cable jacket support surface 260 that defines a recess 262 to allow a tie wrap to pass between the surface 260 (in the recess 262) and the outer jacket of the cable to secure the cable at a jacket fixation portion 264 defined by the second body piece 234. Teeth 266 are positioned on the jacket fixation portion 264 and configured to dig into the cable jacket to help secure it.

The second body piece 234 includes a shoulder stop 268 configured to help place the distal end of the cable jacket when securing the cable to the second body piece 234. Thus, the shoulder stop 268 is configured to inhibit distal movement of the cable jacket when an axial end of the cable jacket abuts the proximally facing surface 270 of the shoulder 268.

The jacket fixation portion 264 includes notches 272 and fully enclosed openings 274 that receive tie wraps that are wrapped around the outer jacket of a cable in order to fix the outer jacket to the second body piece 234.

The second body piece 234 defines a proximal notch 276 and a distal notch 278 that is aligned with the proximal notch along the proximal to distal dimension. The notches 276 and 278 are configured to receive the strength yarn 69 (e.g., aramid yarn) extending from the cable fixed to the second body piece 234. That is, the strength yarn 69 can be anchored by winding it around the second body piece 234 through the notches 276 and 278, and then tied off. In this manner, both the outer jacket of the cable and the strength yarn are fixed to the second body piece 234, which can minimize deleterious impact of a lateral load experienced by the cable on any optical fibers carried by the cable.

When lockingly coupled together, the jacket fixation portion 264 is offset proximally from the jacket fixation portion 240. This offset can prevent interference between, e.g., the tie wraps used to secure the two cables.

The first and second body pieces include a coupling mechanism to interlock the two body pieces together. In some examples, the coupling mechanism allows the body pieces to be unlocked from each other and separated, e.g., if the device 220 has been used to secure two cables and subsequently is needed to secure just one cable.

The figures depict a non-limiting example of a coupling mechanism. In the example depicted, each body piece 232, 234 includes complementary coupling elements. In alternative examples, the coupling elements can have different configurations and/or be positioned on different ones of the two body pieces.

The first body piece 232 includes a bar 284 and a locator 282 extending laterally and downward from the bar 284. The bar 284 and the locator 282 define slots 280 on proximal and distal sides of the locator 282. The first body piece 232 also includes a pair of shoulders 292 and 294 on either side of the locator 282. The shoulders 292 and 294 are each vertically aligned with a slot 280. The first body piece 232 also includes a horizontal engagement surface 296 that abuts the locator 282.

The second piece 234 includes downwardly projecting tabs 286 having catches 288 at their free ends. A keying notch 290 is defined between the tabs 286, with the tabs 286 being positioned on proximal and distal sides of the keying notch 290.

To interlock the first body piece 232 and the second body piece 234, the tabs 286 of the second body piece 234 are downwardly inserted into the slots 280 until the catches 288 snappingly engage under the shoulders 292, 294. The coupling elements are sized and positioned such that when the catches 288 snappingly engage the shoulders 292, 294, recessed surfaces 298 of the second body piece 234 abut the horizontal engagement surface 296, acting as a downward stop for the second body piece 234. In addition, the keying notch 290 receives the locator 282 to provide further stability to the interlocking of the body pieces, as well as to properly downwardly guide the second body piece 234 into locking engagement with the first body piece 232. The bar 284 and a retainer 299 of the first body piece 232 retain the second body piece 234 and minimize side to side movement of the second body piece 234 relative to the first body piece 232 when two body pieces are interlocked.

The retainer 299 and the bar 284 are positioned on opposite sides of the slots 280 to provide retention of the second body piece 234 with respect to both directions of side to side movement (parallel to the axis 18 (FIG. 1)). The retainer 299 and the bar 284 can be vertically offset from each other as shown. This configuration can allow sufficient clearance for the catches 288 as they descend through the slots 280, until they flex and resiliently return to their unflexed position to snappingly engage the shoulders 292, 294. Thus, in this example, the first and second body pieces 232 and 234 can snappingly interlock with each other.

The second body piece 234 includes an elongate member 300 extending proximally to a proximal free end 302 of the second body piece 234. The elongate member 300 includes a non-recessed portion of the cable jacket support surface 260. At the free end 302, the elongate member 300 defines a sealing element support 304. A sealing element, such as a piece of gel 306 (FIG. 19) can be mounted to the sealing element support 304 and seal off any gap that may form between the two cables 60a and 60b when both are secured to the device.

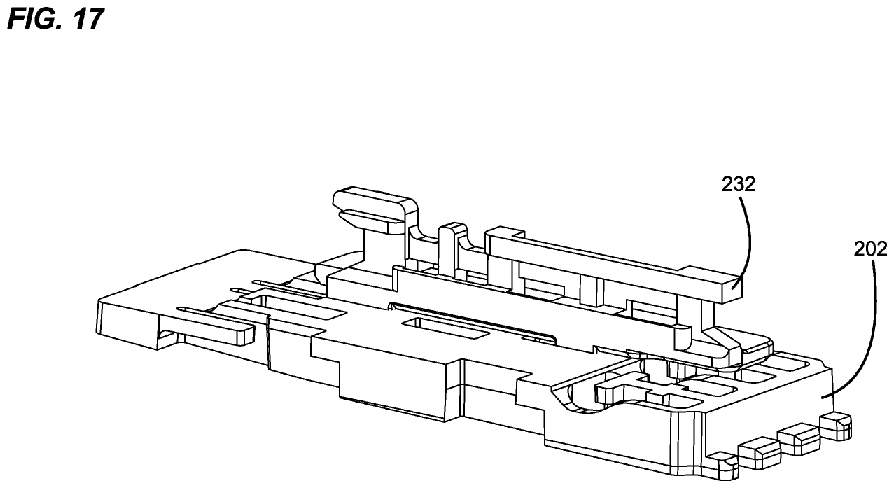

Thus, when only one cable is secured to the device, the second body piece 234 is not needed (FIGS. 17-18), and so the device does not include the second body piece 234, or any of the features of the second body piece, such as the elongate member 300 or the sealing element support 304. If an additional cable is needed at the cable entry point for the closure, the second body piece 234 can be lockingly attached the first body piece 232, a sealing element 306 can be mounted to the sealing element support 304, and the second cable can be secured to the second body piece 234.

Example methods of using the device 220 will now be described. It will be appreciated that a multi-piece cable fixation device with interlocking body pieces provides versatility and flexibility in how cables and different numbers of cables can be fixed to a closure, including a variety of different orders of operations that may benefit the technician depending on the specific circumstances facing the technician.

In one example method, it is desired initially to secure two drop cables to the device 220. In this scenario, a first cable with stripped outer jacket is secured (e.g., with one or more tie wraps) to the first body piece 232. In addition, optionally the strength yarn of the first cable can be wound around, and anchored to, the first body piece 232. Subsequently a second cable with stripped outer jacket is secured (e.g., with one or more tie wraps) to the second body piece 234. In addition, optionally the strength yarn of the second cable can be wound around, and anchored to, the second body piece 234. Subsequently, the first and second body pieces 232 and 234 are interlocked together. Subsequently, the device 220 is lockingly mounted to a baseplate (e.g., the baseplate 202). In some examples, the baseplate is pre-installed on the main support structure 111. In other examples, the baseplate is installed on the main support structure 111 after the device 220 is lockingly mounted to the baseplate. In addition, the method includes mounting a sealing element 306 on the sealing element support 304 to be positioned between the cables. In an alternative embodiment of the foregoing method, the first and second body pieces 232 and 234 are interlocked together before the cables are secured thereto, and the cables can be secured first and second bodies in any order (e.g., the first cable is first secured to the first body followed by the second cable being secured to the second body piece, or the second cable is secured to the second body piece and then the first cable is secured to the first body piece). The device 220, including both body pieces 232 and 234 interlocked and with cables secured thereto is then mounted to the baseplate.

In another example method, it is desired initially to secure just one drop cable to the cable fixation device. In this scenario, a first cable with stripped outer jacket is secured (e.g., with one or more tie wraps) to the first body piece 232, without the second body piece 234 being coupled to the second body piece 234. In addition, optionally the strength yarn of the first cable can be wound around, and anchored to, the first body piece 232. Subsequently, the first body piece 232 (representing the cable fixation device 220) is lockingly mounted to a baseplate (e.g., the baseplate 202). In some examples, the baseplate is pre-installed on the main support structure 111. In other examples, the baseplate is installed on the main support structure 111 after the cable fixation device 220 is lockingly mounted to the baseplate. Because there is no second body piece, and because there is only one cable, there is no need for a sealing element 306, nor does the cable fixation device 220 include a sealing element support 304. In an alternative embodiment of the foregoing method, it becomes desirable at a time following the foregoing steps to add a second cable fixation to the cable fixation device. In this example, the second body piece 234 can be provided and the second cable with an outer jacket portion being stripped is secured to the second body piece 234, including e.g., winding strength yarn of the second cable, and securing it to, the second body piece 234. Subsequently, the first and second body pieces 232 and 234 are interlocked together. Thus, in this example, the first body piece 232 need not be removed from the baseplate, nor does the first cable need to be removed from the first body piece 232 in order to increase the size of the cable fixation device and secure a second cable thereto. In addition, the alternative embodiment of this method can include mounting a sealing element 306 on the sealing element support 304 to be positioned between the two cables.

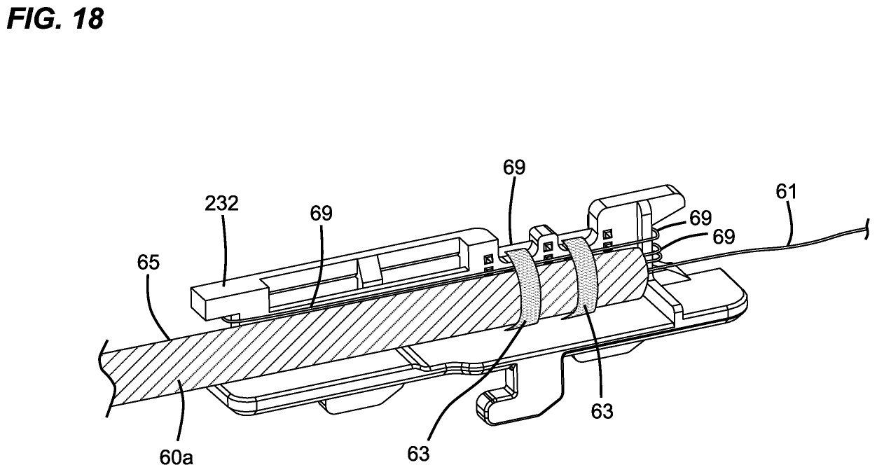

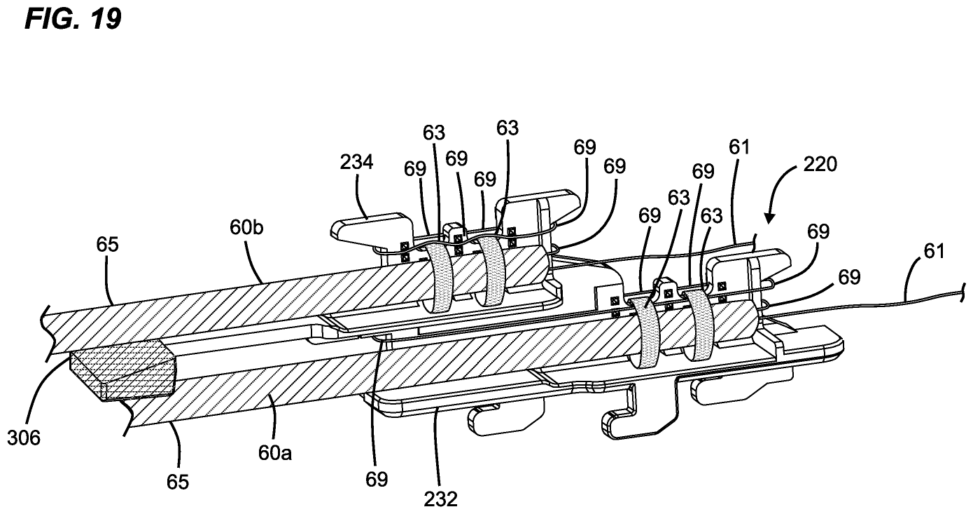

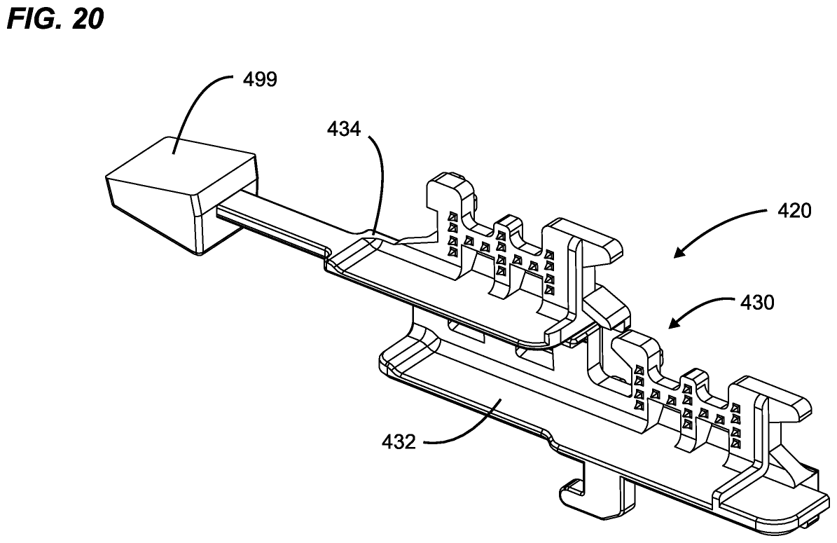

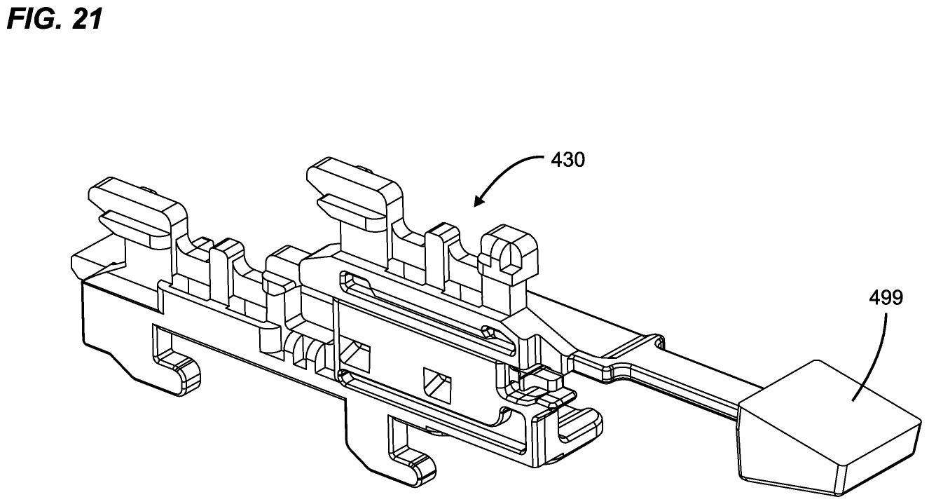

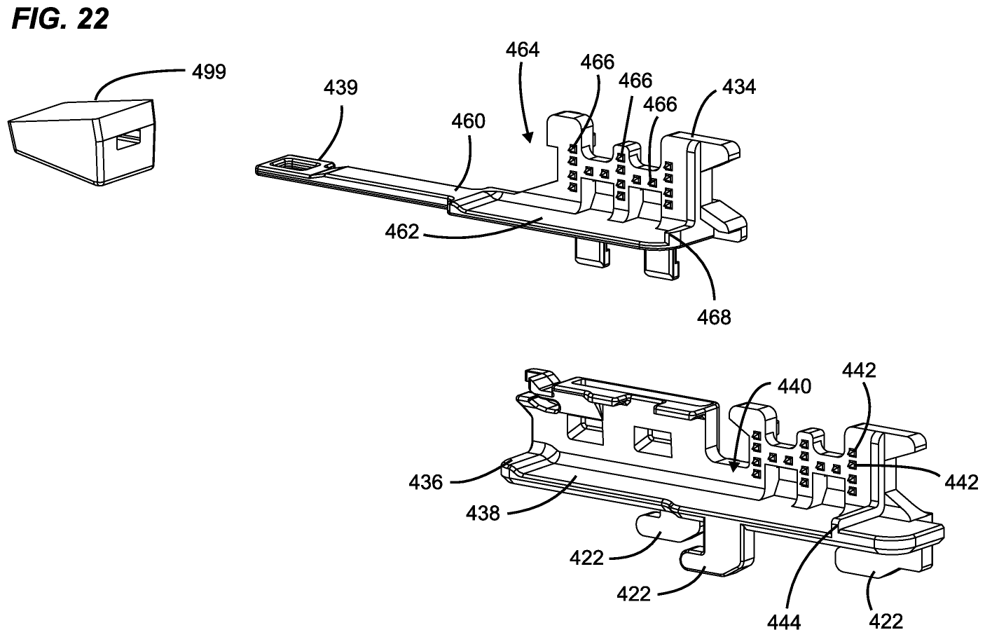

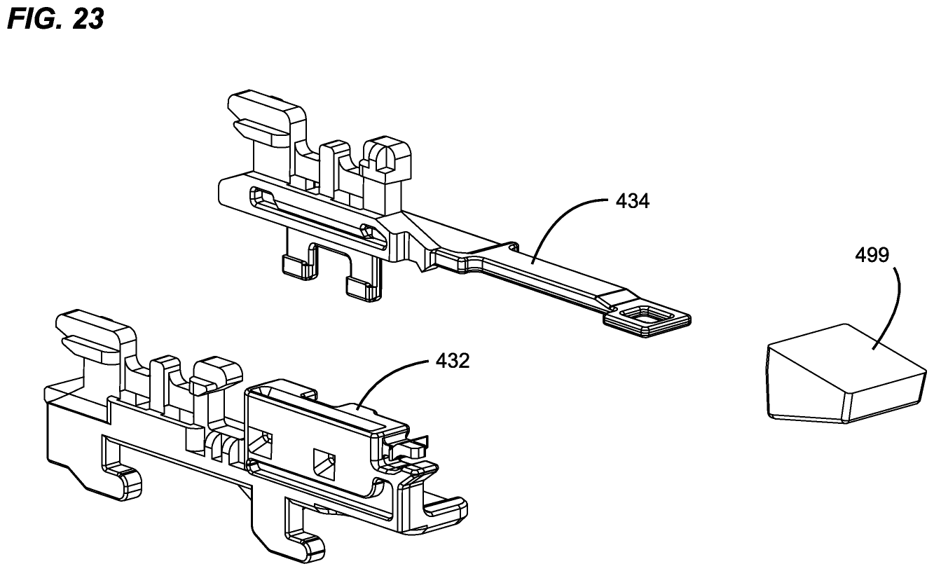

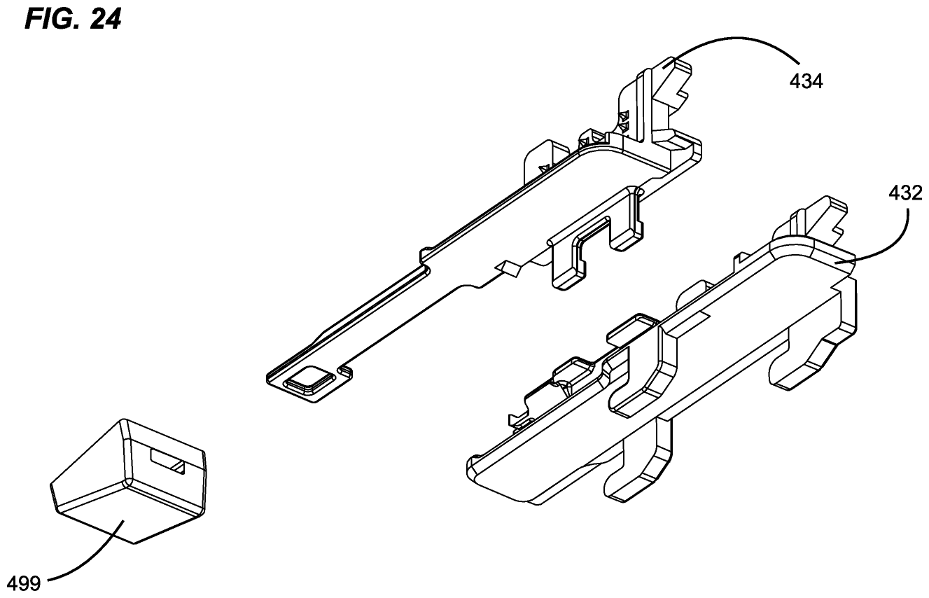

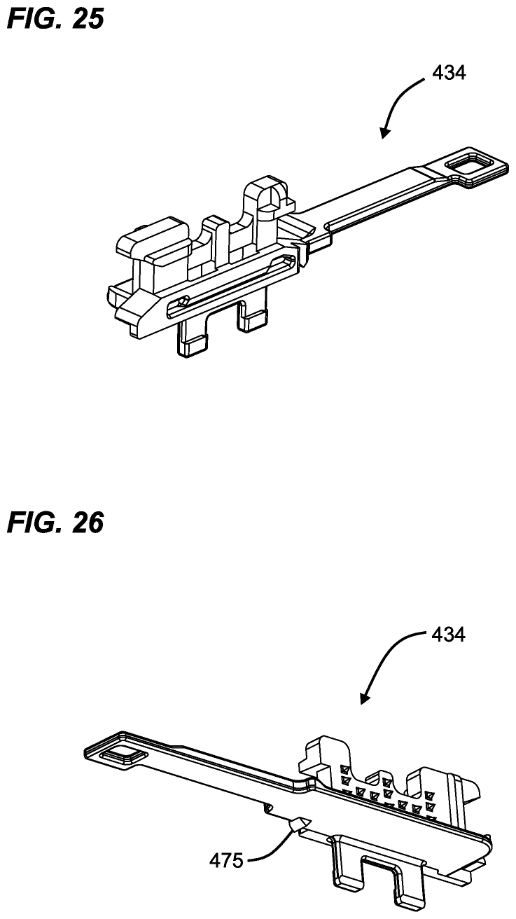

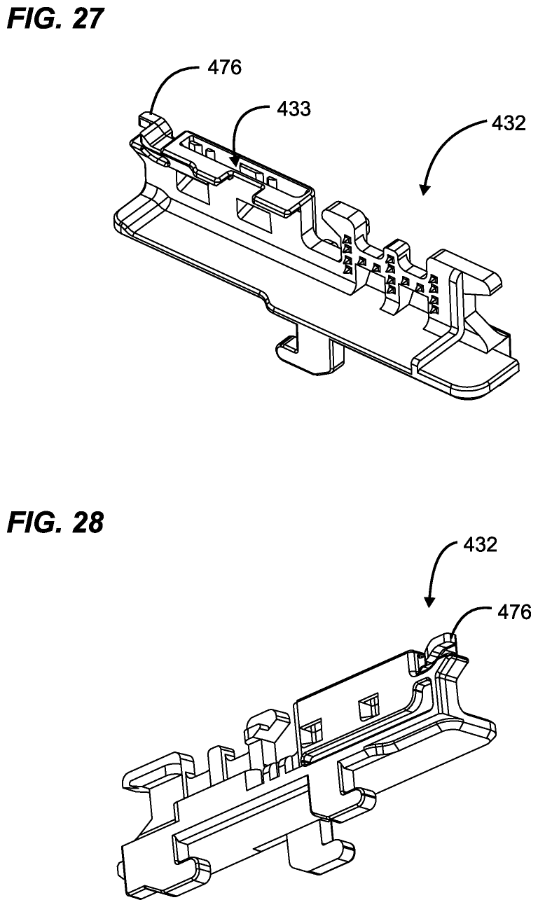

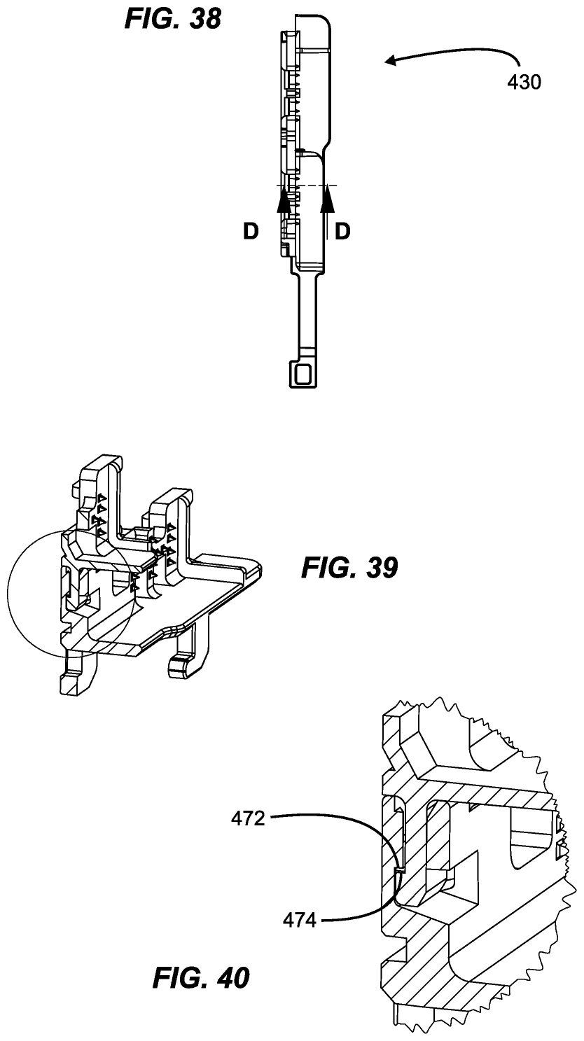

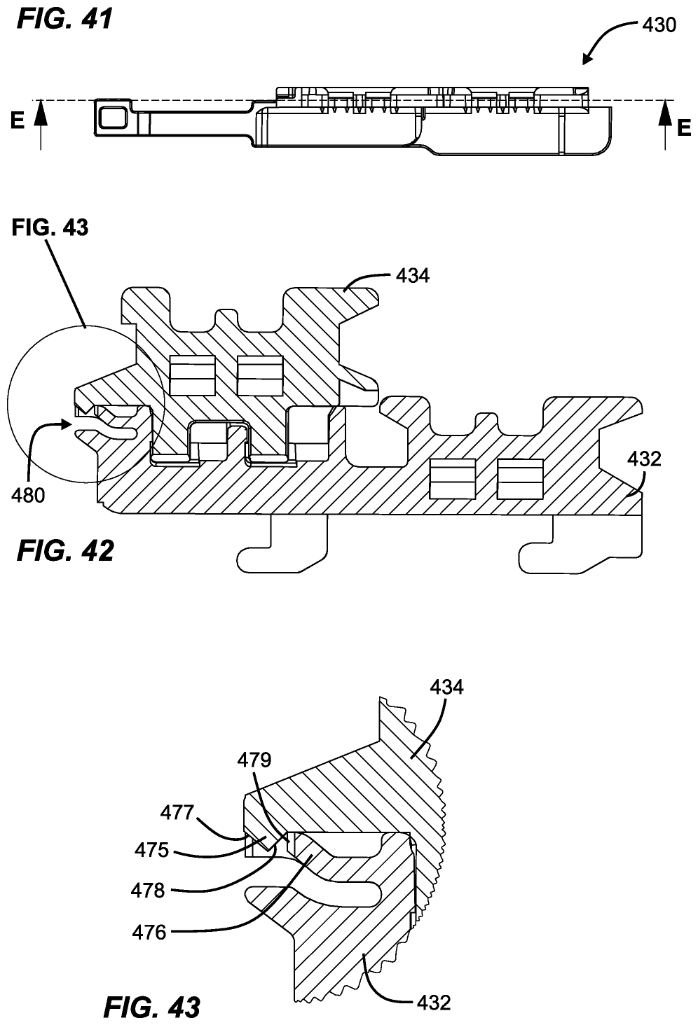

Referring to FIGS. 20-43, a further example of a cable fixation device 420 will be described. The baseplate 202 can serve as a platform to properly vertically align the device 420 with a cable port defined by the seal blocks, as described above with respect to the device 220.

The cable fixation device 420 is configured to be customized for fixing one or two cables. Typically, an outer jacket of a cable is affixed to the body of a cable fixation device before being mounted to a baseplate. The baseplate is typically mounted to the main support structure of the optical fiber organizer before the cable fixation body is mounted to the baseplate.

The device 420 can provide the same cable number customizability functionality as the device 220 described above.

The device 420 is configured to clamp with tie wraps (e.g., with zip ties) non-connectorized drop cables whose outer jackets have had their distal portions stripped, exposing the optical fiber(s) and strength yarn.

The device 420 includes a fixation body 430. The fixation body 430 includes a first (or lower) body piece 432 and a second (or upper) body piece 434 that are configured to lockingly interface with each other.

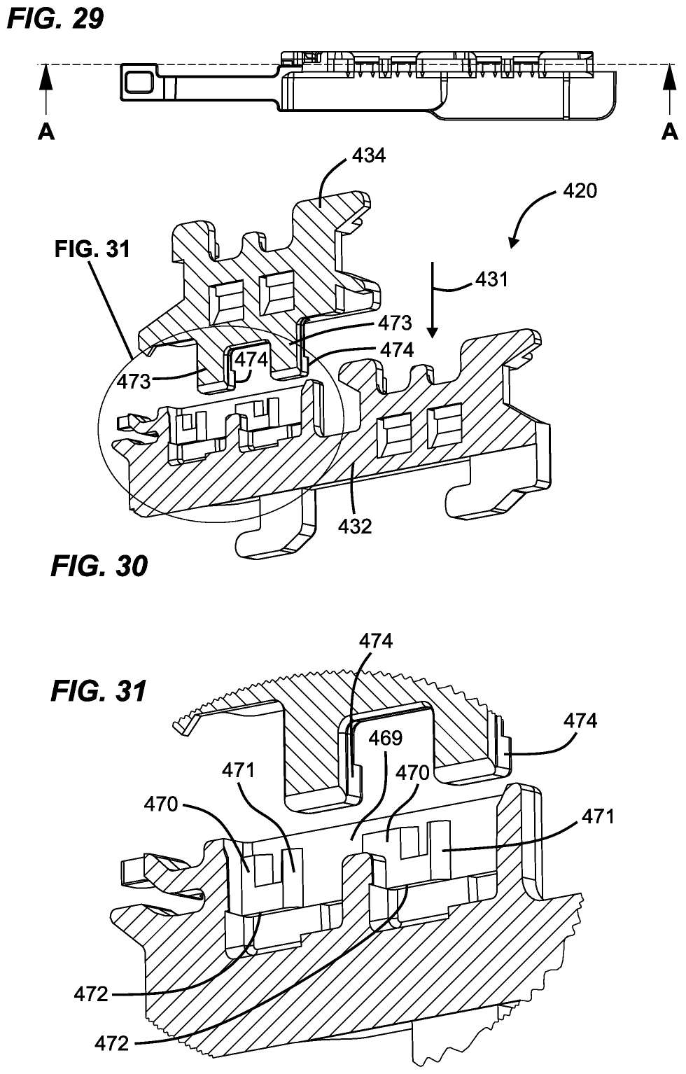

The fixation body 430 is configured to define a first configuration, as shown in FIG. 30, in which the first body piece 432 and the second body piece 434 are not lockingly interfaced with each other.

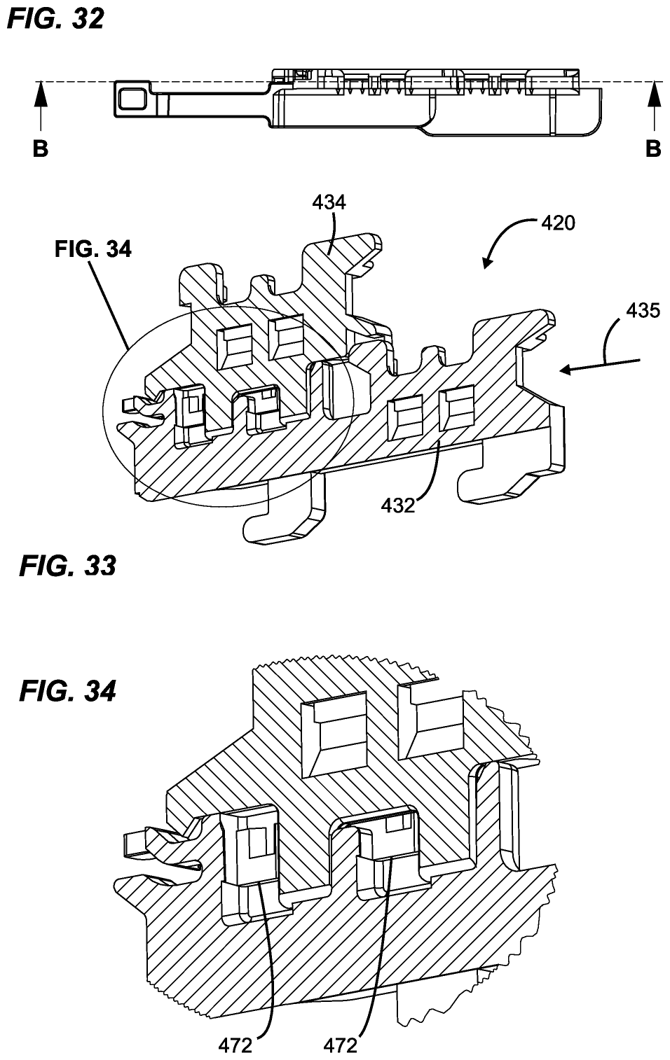

The fixation body 430 is configured to define a second configuration or staged configuration, as shown in FIG. 33, in which the first body piece 432 and the second body piece 434 are engaged but not lockingly interfaced with each other. To convert the device from the first configuration to the second configuration, the second body piece 434 is moved downward parallel to the arrow 431 into engagement with a pocket 433 defined by the first body piece 432.

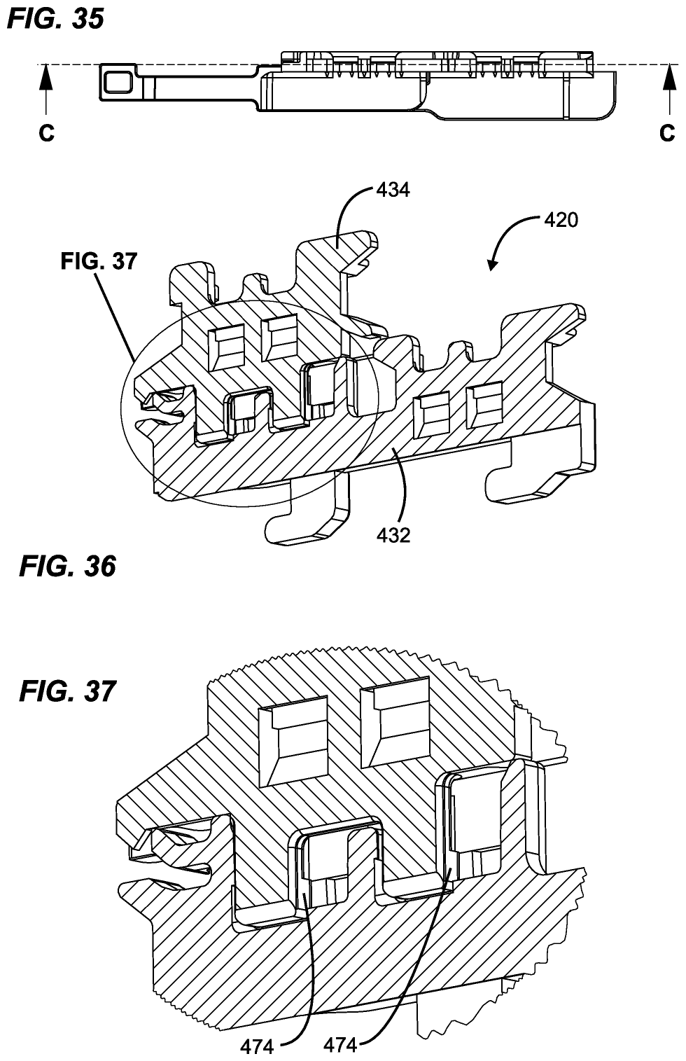

The fixation body 430 is configured to define a third configuration, as shown in FIG. 36, in which the first body piece 432 and the second body piece 434 are engaged and lockingly interfaced with each other. To convert the device from the second configuration to the third configuration, the second body piece 434 is moved within the pocket 433 proximally, parallel to the arrow 435 into locking engagement with the first body piece 432.

Depending on the configuration, the body 430 can fix one or two cables, as described above. A seal element 499 (e.g., a gel piece or gel pieces) can be mounted to a mounting structure (or sealing element support) 439 of the elongate member of the second body piece 424 when two cables are mounted to the body 430 to provide adequate sealing between the two cables as they enter the closure. The seal element 499 can seal off any gap that may form between the two cables when both are secured to the body 430.

In some examples, the first body piece 432 and the second body piece 434 are each a molded polymeric material.

The first body piece 432 includes the hook members 422. The first body piece 432 includes a cable jacket support surface 436 that defines a recess 438 to allow a tie wrap to pass between the surface 436 (in the recess 438) and the outer jacket of the cable to secure the cable at a jacket fixation portion 440 defined by the first body piece 432. Teeth 442 are positioned on the jacket fixation portion 440 and configured to dig into the cable jacket to help secure it.

The first body piece 432 includes a shoulder stop 444 configured to help place the distal end of the cable jacket when securing the cable to the first body piece 432. Thus, the shoulder stop 444 is configured to inhibit distal movement of the cable jacket when an axial end of the cable jacket abuts the proximally facing surface shoulder stop 444.

The jacket fixation portion 440 includes notches and fully enclosed openings that receive tie wraps that are wrapped around the outer jacket of a cable in order to fix the outer jacket to the first body piece 432, as described above in connection with device 230.

The first body piece 432 includes structures to fix cable strength yarn as described above in connection with the device 230.

The second body piece 434 includes a cable jacket support surface 460 that defines a recess 462 to allow a tie wrap to pass between the surface 460 (in the recess 462) and the outer jacket of the cable to secure the cable at a jacket fixation portion 464 defined by the second body piece 434. Teeth 466 are positioned on the jacket fixation portion 464 and configured to dig into the cable jacket to help secure it.

The second body piece 434 includes a shoulder stop 468 configured to help place the distal end of the cable jacket when securing the cable to the second body piece 434. Thus, the shoulder stop 468 is configured to inhibit distal movement of the cable jacket when an axial end of the cable jacket abuts the proximally facing surface of the shoulder 468.

The second body piece 434 is configured to receive tie wraps as described in connection with the second body piece 234. The second body piece 434 includes structures to fix cable strength yarn as described above in connection with the body 430.

When lockingly coupled together, the jacket fixation portion 464 is offset proximally from the jacket fixation portion 440. This offset can prevent interference between, e.g., the tie wraps used to secure the two cables.

The first and second body pieces include a coupling mechanism to interlock the two body pieces together. In some examples, the coupling mechanism allows the body pieces to be unlocked from each other and separated, e.g., if the body 430 has been used to secure two cables and subsequently is needed to secure just one cable.

The figures depict a non-limiting example of a coupling mechanism. In the example depicted, each body piece 432, 434 includes complementary coupling elements. In alternative examples, the coupling elements can have different configurations and/or can be positioned on different ones of the two body pieces.

The first body piece 432 defines the pocket 433. Within the pocket 433 are projections 470 projecting from a surface 469 of the pocket 433. The projections 470 include ramped surfaces 471. The projections 470 define shoulders 472 that are spaced apart from the bottom of the pocket 433.

The second body piece 434 includes downward extensions (or tabs) 473 that define protruding catches 474.

To couple the bodies pieces 432 and 434, the extensions 473 and catches 474 enter the pocket 433 distally of the projections 470 and distally of the ramped surface 471. Then, the second piece 434 is slid proximally, causing the extensions 473 to ride over the ramped surfaces 471 and the projections 470, forming frictional engagement between the pieces 432 and 434, and such that the second piece 434 cannot be lifted out of the pocket 433 due to vertical interference between downward facing surfaces of the shoulders 472 and upward facing surfaces of the catches 474. Thus, the interface between the extensions 473 and the projections 470 locks the two pieces 432 and 434 together vertically and along the side-to-side dimension.

In addition, the body 430 includes a proximal-distal locking mechanism 480. In some examples, the mechanism 480 includes a retainer 475 and a flexibly resilient arm 476. When the second piece 434 is slid within the pocket 433 to its proximal-most position, a retainer 475 of the second piece 434 snaps over a flexibly resilient arm 476 of the first piece 432. The retainer 475 includes a proximal ramped surface 477 and a distal ramped surface 478. The proximal ramped surface 477 can enable the retainer 475 to flex the arm 476 while riding over the arm 476 until the retainer 475 proximally clears the distal and of the arm 476 and the arm 476 resiliently returns to a relaxed configuration as shown in FIG. 43 without the need for a tool (e.g., a fiber pick) to flex the arm 476. Alternatively, a tool, such as a fiber pick, can be used to flex the arm 476 to allow the body piece 434 to be moved into the fully engaged configuration with the body piece 432.

When fully engaged, the second piece 434 is locked with respect to the first piece 432 parallel to the proximal to distal dimension due to the interference interface between the surface 478 and the proximally facing surface 479 of the arm 476.

To unlock and disengage the pieces 432 and 434, the piece 434 can be pulled distally with sufficient force for the surface 478 to ride over and flex the arm 476 downwards, so that the retainer 475 can clear the end portion of the arm 476 distally. Alternatively, the arm 476 can be flexed downward with a tool, such as a fiber pick, allowing the retainer to easily clear the distal end of the arm 476 distally. The piece 434 can then be moved further distally until the extensions 473 clear the projections 470, at which point the piece 434 can be lifted upward out of the pocket 433 to de-couple the pieces 432 and 434.

Thus, when only one cable is secured to the device, the second body piece 434 is not needed, and so the device does not include the second body piece 434, or any of the features of the second body piece, such as the sealing element 499. If an additional cable is needed at the cable entry point for the closure, the second body piece 434 can be lockingly attached to the first body piece 432, a sealing element 499 can be mounted to the sealing element support, and the second cable can be secured to the second body piece 434.

Principles of methods of using the device 420 for one or two cables are consistent with those described above with respect to the device 220.

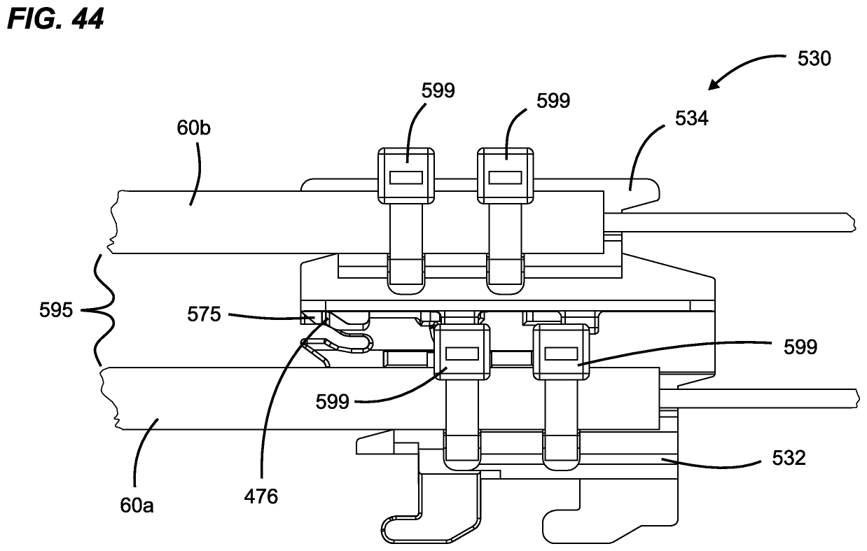

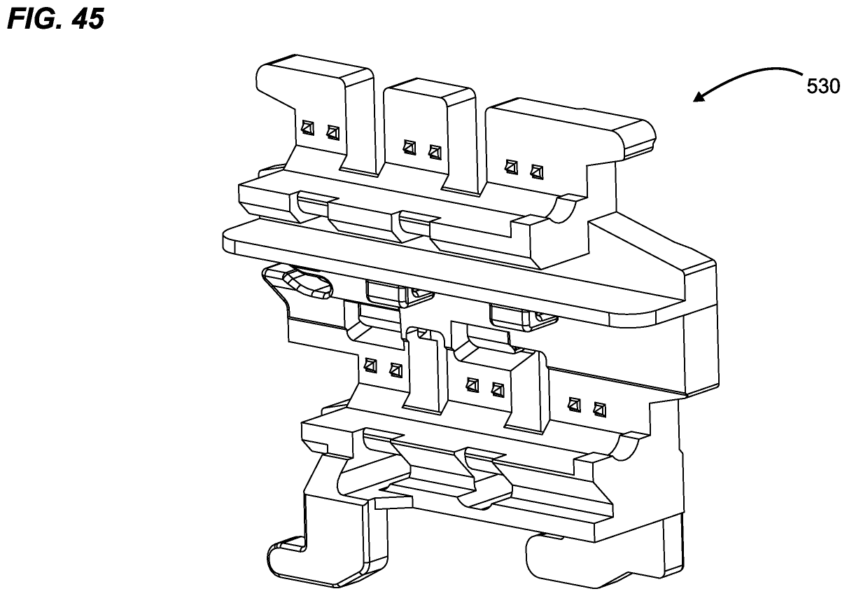

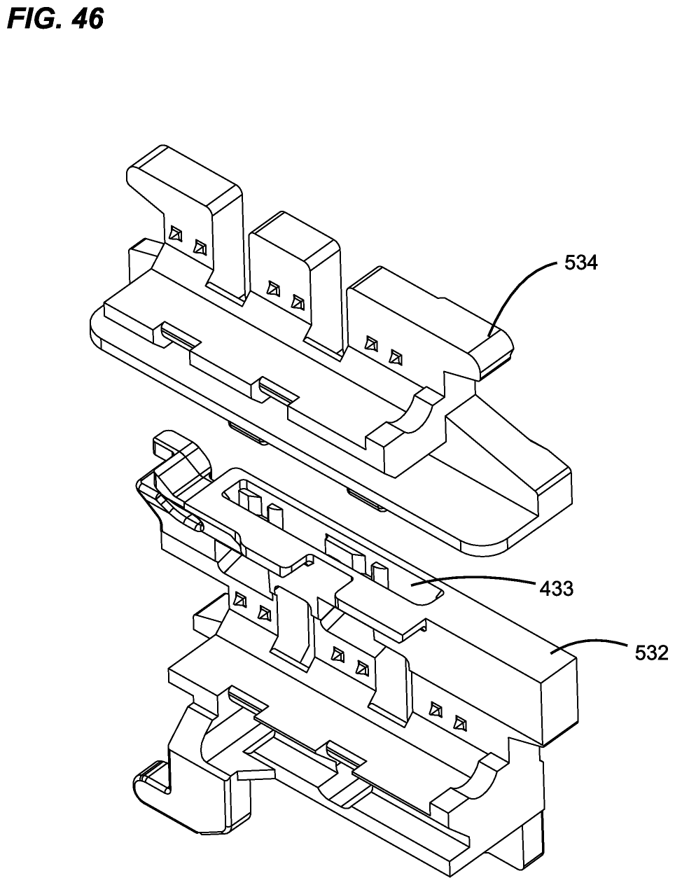

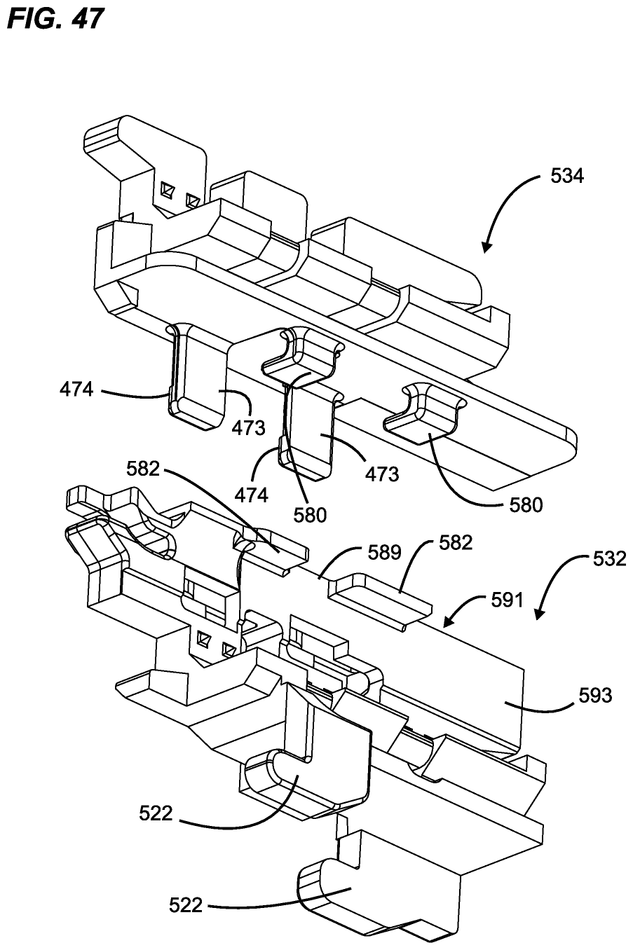

Referring now to FIGS. 44-47, a further example of a body 530 of a cable fixation device will be described. The baseplate 202 can serve as a platform to properly vertically align the body 530 with a cable port defined by the seal blocks, as described above with respect to the devices 420, 220.

The body 530 includes many features in common with the body 430 described above. In the interest of brevity, the following description will focus largely on differences between the body 530 and the body 430.

The body 530 can provide the same cable number customizability functionality as the devices 220 and 420 described above. However, unlike the devices 220 and 420, the body 530 is sized and configured such that when cables 60a and 60b are fixed with tie wraps 599 to the body 530, there is a sufficiently large vertical gap 595 between the cables 60a and 60b, such that the closure's seal blocks can seal around each cable 60a and 60b individually and adequately, without the need for an additional seal element, such as the seal element 499, 306 described above. That is, for a given pair of cables, a supplemental seal element 499, 306 can be required for adequate sealing when using the body 230, 430, but may not be required for adequately sealing when using the body 530.

The fixation body 530 includes a first (or lower) body piece 532 and a second (or upper) body piece 534 that are configured to lockingly interface with each other. The locking interface and locking and unlocking methods for the pieces 532 and 534 of the body 530 are identical to the locking interface and the locking and unlocking methods of the pieces 432 and 434 of the body 430 described above, except that the retainer 575 of the piece 534 has a vertical, rather than a ramped, distally facing surface, such that a tool (e.g., a fiber pick), may be required to flex the arm 476 in order to decouple and unlock the pieces 532 and 534. In addition, unlike the coupling mechanism for the body piece 432 and 434, the piece 534 includes additional hooks 580 that are staggered with respect to the extensions 473 on an opposite side of the proximal to distal axis of the body 530. Due to the staggering, the hooks 580 and the extension 473 are not aligned along the side-to-side dimension. When the piece 534 downwardly engages the piece 532, the hooks 580 enter spaces or gaps 589, 591 defined by the piece 532. Then, when the piece 534 is subsequently moved proximally, the hooks 580 slide under tabs 582 projecting sideways from a vertical surface 593 of the piece 532, thereby providing additional stability to the locking interface between the pieces 532 and 534, with upward facing surfaces of the hooks 580 vertically interfering with downward facing surfaces of the tabs 582.

Depending on the configuration, the body 530 can fix one or two cables, as described above.

In some examples, the first body piece 532 and the second body piece 534 are each a molded polymeric material.

Unlike the pieces 232 and 432, the piece 532 includes only two hook members 522, providing for a more compact device in the proximal to distal dimension. Because an additional seal element and support structure for the additional seal element are not needed, the proximal to distal dimension can be shortened, such that only two hook members 522 are needed. Not needing a supplemental seal element can further simplify the assembly.

In some examples, when lockingly coupled together, the jacket fixation portions of the pieces 532 and 534 are offset from each other along the proximal to distal dimension. This offset can prevent interference between, e.g., the tie wraps used to secure the two cables.

When only one cable is secured to the device, the second body piece 534 is not needed, and so the device does not include the second body piece 534. If an additional cable is needed at the cable entry point for the closure, the second body piece 534 can be lockingly attached the first body piece 532 and the second cable can be secured to the second body piece 534.

Principles of methods of using the body 530 for one or two cables are consistent with those described above with respect to the devices 220 and 420, except that a sealing member is not needed, as already described.

From the foregoing detailed description, it will be evident that modifications and variations can be made in the devices of the disclosure without departing from the spirit or scope of the invention.

What is claimed is:

1. A fixation device assembly for fixing one or more cables in a telecommunications closure, comprising,
a fixation body, the fixation body including a first body piece and a second body piece configured to lockingly interface with each other, the fixation device assembly being configured to define a first fixation configuration in which the first body piece and the second body piece are not lockingly interfaced with each other, and a second fixation configuration in which the first body piece and the second body piece are lockingly interfaced with each other, the fixation device assembly being adapted in the first configuration to fix a first cable to the first body piece, the fixation device assembly being adapted in the second configuration to fix the first cable to the first body piece and a second cable to the second body piece.

2. The assembly of claim 1, wherein each of the first body piece and the second body piece includes a cable support surface.

3. The assembly of any of claims 1-2, wherein each of the first body piece and the second body piece includes at least one hole to receive a tie wrap to secure the first cable and the second cable to the first body piece and the second body piece, respectively.

4. The assembly of any of any of claims 1-2, wherein each cable support surface includes a recessed portion.

5. The assembly of claim 3, wherein each cable support surface includes a recessed portion configured for a tie wrap to be looped around each of the first cable and the second cable, respectively, and further configured for each tie wrap to be positioned between an outer jacket of each cable and a corresponding one of the cable support surfaces at the recessed portion.

6. The assembly of any of claims 1-5, wherein the second body piece includes an elongate member defining a sealing element support.

7. The assembly of claim 6, further comprising a sealing element secured to the sealing element support.

8. The assembly of any of claims 1-7, wherein each of the first body piece and the second body piece defines a cable fixation portion configured to receive tie wraps, and wherein when the first and second body pieces are interlocked, the cable fixation portions are offset from each other parallel to an elongate dimension of the fixation device assembly.

9. The assembly of any of claims 1-8, wherein each of the first body piece and the second body defines notches for routing and securing cable strength yarn.

10. The assembly of any of claims 1-9, wherein the first body piece and the second body piece are not of identical construction.

11. The assembly of any of claims 1-10, wherein the first body piece and the second body piece are configured to snappingly interlock.

12. The assembly of claim 11, wherein the first body piece includes at least one first coupling element and the second body piece includes at least one second coupling element configured to interlock with the at least one first locking element.

13. The assembly of claim 12,
wherein the at least one first coupling element includes a slot and a shoulder; and
wherein the at least one second coupling element includes a tab having a catch, the tab being configured to be inserted in the slot until the catch snappingly engages the shoulder.

14. The assembly of claim 13, wherein the first and second coupling elements are sized and positioned such that when the catch snappingly engages the shoulder, a recessed surface of the second body piece abuts a complementary engagement surface of the first body piece.

15. The assembly of any of claims 13-14, wherein when the catch snappingly engages the shoulder, a keying notch of the second body piece receives a locator of the first body piece.

16. The assembly of any of claims 13-15, wherein the at least one first coupling element includes a bar and a retainer configured to retain a portion of the second body piece therebetween and within the slot.

17. The assembly of claim 16, wherein the bar and the retainer are offset from each other parallel to a direction of insertion of the tab into the slot to interlock the first and second body pieces.

18. The assembly of any of claims 1-17, wherein the first body piece, but not the second body piece, includes hook members for installing the first body piece on a baseplate defining slots, the hook members being configured to be received in the slots.

19. A telecommunications enclosure, comprising:
first and second housing pieces configured to cooperate to define a sealable and re-enterable enclosure volume;
a main support structure positioned in the enclosure volume; and
the assembly of claim 18 positioned in the closure volume, the baseplate being mounted to the main support structure, the assembly including tie wraps tying the cables to the first and second body pieces, the cables extending through cable ports defined by seal blocks of the enclosure.

20. A method of fixing one or more cables in a telecommunications closure, comprising steps of:
(a) providing a first body piece of a cable fixation device assembly;
(b) fixing a first cable to the first body piece;
(c) subsequent to the step (b), fixing a second cable to a second body piece of the cable fixation device assembly; and
(d) subsequent to the step (b), interlocking the second body piece and the first body piece.

21. The method of claim 20, wherein the step (c) is performed before the step (d).

22. The method of claim 20, wherein the step (d) is performed before the step (c).

23. The method of any of claims 20-22, further comprising:
(e) mounting the first body piece to a baseplate.

24. The method of claim 23, wherein the step (e) is performed subsequent to the step (d).

25. The method of any of claims 23-24, further comprising:
(f) mounting the baseplate to a main support structure of an optical fiber organizer.

26. The method of claim 25, wherein the step (f) is performed before the step (e).

27. The method of any of claims 20-26, wherein the fixing a first cable includes securing an outer jacket of the first cable to the first body piece with a tie wrap, and wherein the fixing a second cable includes securing an outer jacket of the second cable to the second body piece with a tie wrap.

28. The method of any of claims 20-27, wherein the fixing a first cable includes winding strength yarn of the first cable around the first body piece, and wherein the fixing the second cable includes winding strength yarn of the second cable around the second body piece.

29. A method of fixing one or more cables in a telecommunications closure, comprising steps of:
(a) providing a first body piece of a cable fixation device assembly;
(b) fixing a first cable to the first body piece;
(c) subsequent to the step (b), mounting the first body piece to a baseplate;
(d) subsequent to the step (c), fixing a second cable to a second body piece of the cable fixation device assembly; and
(e) subsequent to the step (d), interlocking the second body piece and the first body piece while the first body piece remains mounted to the baseplate.

30. The method of claim 29, further comprising:
(f) mounting the baseplate to a main support structure of an optical fiber organizer.

31. The method of claim 30, wherein the step (f) is performed before the step (c).

32. The method of any of claims 29-31, wherein the fixing a first cable includes securing an outer jacket of the first cable to the first body piece with a tie wrap.

33. The method of any of claims 29-32, wherein the fixing a first cable includes winding strength yarn of the first cable around the first body piece.

34. The method of any of claims 20-33, wherein the interlocking includes sliding engagement of the first body piece and the second body piece relative to each other.

35. The method of claim 34, wherein the sliding includes sliding a tab of the second body piece into a slot defined by the first body piece.

36. The method of any of claims 20-35, further comprising securing a sealing element to a sealing element support structure defined by the second housing piece to position the sealing element between the first cable and the second cable.

37. The method of any of claim 23 or 29, wherein the mounting the first body piece to a baseplate includes inserting hook members of the first body piece into slots defined by the base plate.

38. The assembly of claim 12,
wherein the at least one first coupling element includes a pocket and a ramped projection positioned in the pocket, the ramped projection defining a shoulder; and
wherein the at least one second coupling element includes an extension having a catch, the extension being configured to be inserted in the pocket in a first direction and then slid within the pocket in a second direction perpendicular to the first direction such that the catch lockingly interfaces with the shoulder.

39. The assembly of claim 12,
wherein the at least one first coupling element includes a flexibly resilient arm; and
wherein the at least one second coupling element includes a retainer configured to flex the arm and to lockingly interface with the arm.

40. The assembly of claim 38
wherein the at least one first coupling element includes a flexibly resilient arm; and
wherein the at least one second coupling element includes a retainer configured to flex the arm when the extension is slid within the pocket in the second direction and to lockingly engage the arm.

41. The assembly of any of claims 39-40, wherein the retainer includes at least one ramped surface such that the first body piece and the second body piece can be lockingly coupled without a separate tool.

42. The assembly of any of claims 39-40, wherein the retainer includes two ramped surfaces such that the first body piece and the second body piece can be lockingly coupled to each other and unlocked from each other without a separate tool.

43. The assembly of any of claim 38 or 40-42;
wherein the at least one first coupling element includes tabs; and
wherein the at least one second coupling element includes hooks that lockingly interface with the tabs when the extension is slid within the pocket in the second direction.

44. A fixation device assembly for fixing one or more cables in a telecommunications closure, comprising,
a fixation body, the fixation body including a first body piece and a second body piece configured to lockingly interface with each other, the fixation device assembly being configured to define a first fixation configuration in which the first body piece and the second body piece are not lockingly interfaced with each other, and a second fixation configuration in which the first body piece and the second body piece are lockingly interfaced with each other, the fixation device assembly being adapted in the first configuration to fix a first cable to the first body piece, the fixation device assembly being adapted in the second configuration to fix the first cable to the first body piece and a second cable to the second body piece,
wherein the first body piece includes:
a pocket;
a ramped projection positioned in the pocket, the ramped projection defining a shoulder; and
a flexibly resilient arm; and
wherein the second body piece includes:
an extension having a catch, the extension being configured to be inserted in the pocket in a first direction and then slid within the pocket in a second direction perpendicular to the first direction such that the catch lockingly interfaces with the shoulder; and
a retainer configured to flex the arm when the extension is slid within the pocket in the second direction and to lockingly engage the arm.

45. The assembly of claim 44, wherein the retainer includes at least one ramped surface such that the first body piece and the second body piece can be lockingly coupled without a separate tool.

46. The assembly of claim 44, wherein the retainer includes two ramped surfaces such that the first body piece and the second body piece can be lockingly coupled to each other and unlocked from each other without a separate tool.

47. The assembly of any of claims 44-46,
wherein the first body piece includes tabs; and
wherein the second body piece includes hooks that lockingly interface with the tabs when the extension is slid within the pocket in the second direction.

48. A method of fixing one or more cables in a telecommunications closure, comprising:
providing a first body piece of a cable fixation device assembly; and
interlocking the second body piece and the first body piece by inserting in a first direction a portion of the second body piece into a portion of the first body piece and then sliding in a second direction the portion of the second body piece within the portion of the first body piece, such that the portion of the second body piece interlocks with the first body, the second direction being perpendicular to the first direction.

49. The method of claim 48,
wherein the portion of the first body piece includes an extension having a catch; and
wherein the portion of the second body includes a pocket that receives the extension during the interlocking.
